(19) United States
(12) Patent Application Publication
(10) Pub. No.: US 2002/0087411 A1
(43) Pub. Date: Jul. 4, 2002

(54) Expected value methods ans systems for paying and qualifying

(76) Inventor: Michael Rossides, Scottsdale, AZ (US)

Correspondence Address: Michael Rossides, 11167 E. Mirasol Circle, Scottsdale, AZ, 85259, US

(21) Appl. No.: 10/042,975

(22) Filed: Jan. 7, 2002

Related U.S. Application Data
(63) Continuation-in-part of application No. 09/536,727, filed on Mar. 28, 2000.

(51) Int. Cl. G06F 17/60

(52) U.S. Cl. 705/14

(57) ABSTRACT

A method and system is disclosed for enabling advertisers to pay only qualified people for receiving messages. The method utilizes the expected value (EV) payment method to efficiently pay a recipient and efficiently verify her qualifications. In this method, a recipient is paid an expected payment. The recipient collects an actual payoff only upon winning an EV payment bet and upon passing an inspection process to verify her qualifications. A losing recipient is not owed a payoff and does not have her qualifications inspected. In other words, a recipient's qualifications are verified through random audit where she is selected only if she wins an EV payment bet. Thus, a system that implements the method executes EV payment bets and incorporates an inspection process to verify the qualifications of recipients who win the bets, and authorizes payment to qualified winners.

### CROSS REFERENCES

This application is a continuation in part of U.S. application Ser. No. 09/536,727, filed on Mar. 3, 2000.

This application is preceded by PCT application U.S./18715, filed on Jul. 7, 2000.

### BACKGROUND

Field of the Invention

This invention relates to database systems for paying people for their attention.

### PREFACE: ABOUT THE INVENTION AND THIS SPECIFICATION

Most of this Application is a copy of PCT application U.S./18715. Chapter 40, not present in the PCT application, is brief and provides some new matter and elaborates on certain features discussed in the PCT application.

Repetitive Content

In Parts 1 and 2, this specification describes a general method and system for paying for attention. After these parts, the specification continues as Chapters 10, 20 and 30. These chapters describe a more specific application of the general method. This application involves defining a special kind of sales prospect, called a “realbuyer,” and is so important that we repeat for the sake of clarity. We apologize for the clumsy division of the specification into Parts and Chapters.

A General System for Paying for Attention

In its most general form, the invention is an online database system for enabling a person or company to pay for the attention of people who meet specified qualifications.

Paying people for their attention can be useful in a variety of situations but only if the payer can select the payees based on desired criteria. As some examples, a city might want to pay teenage girls to read literature about birth control, a company might want to pay computer scientists to read a recruitment offer, and the maker of an asthma medicine might want to pay asthma sufferers to read about the medicine.

The invention enables an advertiser to target an audience with precision, according to verifiable criteria, and pay only that audience for its attention.

Expected Value Payment and Post-Qualification Are the Keys to the System

The problem with paying someone for her attention is that it normally costs too much to verify the person's qualifications in advance because the amounts paid are small. For example, if a city wants to pay 13-year-olds $2 to read an article about birth control, it is too costly to check in advance the age of every person who might accept the offer.

A general solution to this problem is to pay people expected amounts of money through the Expected Value Payment Method (EVPM) and to only inspect the qualifications of the winners.

In other words, recipients are paid for their attention with electronic lottery tickets that have a specified EV, with a 1/X chance of paying off. After recipients have paid attention, the results of the tickets are revealed and only the winners (1/X of all the people who have paid attention) are asked to prove that they match the qualifications.

This kind of verification is probabilistic post-qualification. The winners who do not match the qualifications are paid nothing. The winners who match the qualifications are paid X times the EV amount.

For instance, assume that the city of Denver offers to pay $2 to all 13-year-olds who live in Denver and read an article on birth control at the city's website. Assume a set of people then reads the article on the site, which registers the identity of each person who wants to accept the offer. A fraction of that set of people, say 1/500, is chosen randomly to be the set of winners. Each winner is paid 500×$2 ($1,000) if she proves that she is a 13-year-old who lives in Denver. The city does not have to verify, in advance, that the readers are 13-years-old or that they live in Denver, and the city does not have to pay everyone who reads that article, just the winners of the EVPM bets who are also 13 year-olds.

Thus, the EVPM is used both as an efficient payment method and an audit selection method—the people who are inspected and paid are probabilistically chosen. A surprising double-efficiency results: efficient payment and efficient qualification.

And so, we have an efficient, general method for paying only for the attention of people who match specified criteria.

Naming the Offers: EVQ Offers

The invention is a system for enabling advertisers to make what we will call Expected Value Qualification (EVQ) offers to recipients.

An EVQ offer is one where the advertisers agrees to pay the recipient an EV amount of money if the recipient meets the qualifications/conditions set out in the offer.

In other words, what this means is that the advertiser agrees to pay the recipient the payoff of an EV payment bet if the recipient wins the bet AND meets the qualifications/conditions set out in the offer

In the context of this specification, we will also refer to EVQ offers simply as payment offers or offers.

This Specification Describes the Core Processes of the Invention

This specification describes a set of core processes that enable advertisers to pay for the attention of recipients who meet specified qualifications. In brief, these processes do the following:

enable advertisers to make and post EVQ payment offers

enable recipients to find and accept those offers

enable advertisers to verify the qualifications of the recipients

enable advertisers to pay recipients who qualify.

By core processes we mean the sequences of steps that the system executes to achieve its minimum purpose to enable advertisers to offer to pay and qualify recipients using the EV payment method.

Many features can be added to the set of core processes in order to adapt the invention to particular applications. By analogy we might think of the set of core processes as an elemental design, like the design of a vehicle with four wheels. It can be adapted in a great variety of ways: a car, a truck, a bus, a tractor, and so forth. Likewise, the core invention disclosed here can be adapted in a wide variety of ways.

In future continuing applications we will delve into more specific embodiments of the invention. In this specification, we will illustrate with two embodiments. With these embodiments do not mean to limit the invention, which is a pioneering invention that will have a great variety of specific implementations.

The Core Processes Can Be Implemented for a Variety of Media

Since there is not just one kind of “attention” the invention can enable advertisers to pay for different kinds of attention and pay recipients for receiving different kinds of messages. We will describe the core processes first without having any specific type of message in mind.

As reduced to practice, the invention will need to have a front-end and other features that are suitable to the kind of medium for getting a recipient's attention to a message: webpage, one-way video, interactive video, phone call, “instant message”, email. The invention can also be applied to pay recipients for participating in face-to-face meetings.

We will illustrate the invention with a webpage application and a phone call application.

Pay-for-Placement Directory Implementation

Payment offers can be stored in a “non-competitive” database whose purpose is simply to enable recipients to find and accept the offers. Another kind of system is a competitive, auction/directory—a pay for placement system—in which offers are presented according search term and payment offered to the recipient. A pay-for-placement directory will likely be a very useful form of the invention because it enables market forces to determine the priority by which pay-for-attention offers are seen.

Naming the Invention: System for Paying and Qualifying (SPQ).

The invention is a set of methods (processes) that, in combination, direct a computer database system to perform useful functions. The full name of the invention is Expected Value Methods and Systems for Paying and Qualifying. We will abbreviate it to System for Paying and Qualifying (SPQ).

Referring to the Invention Anthropomorphically

For brevity we often refer to the SPQ anthropomorphically and assume that the reader realizes that when we say, “SPQ does so-and-so”, we mean, “The system for paying and qualifying includes functions for doing so-and-so.”

Usage of the Terms Process, Procedure and Program

The invention is a computer database system that executes a set of processes to accomplish certain tasks. In this specification, we use the terms process, procedure and program synonymously to refer to a set of steps that the computer executes.

Usage of the Terms Advertiser, Recipient and Qualified Recipient

When we use the term advertiser we mean a person or organization that wants to pay for a qualified recipient's attention to a message. The advertiser sets the qualifications.

Accordingly, when we say a recipient, we mean someone who can receive the advertiser's message. When we say qualified recipient we mean someone who meets the advertiser's qualifications for payment.

Defining and Naming Data Records

In this specification we define and name several kinds of data records (which may also be called files or objects). In giving these definitions, we are not trying to say exactly how the system would store information. Our goal is just to explain the kinds of information that SPQ would store. Those skilled in the art will easily see alternative ways to name and store this information.

“Data Field” May Refer to a Single Field or Multiple Fields

For the sake of brevity, rather than say a “data field or fields” we will usually just say “a field” or “the field”. When using the term “field” the point is to state that the system registers a particular, named piece of information or set of information.

The information in the field might actually require multiple fields (e.g., a legal name field might be split into three fields: first name, last name, middle initial). Those skilled in the art will know where multiple fields are more appropriate than a single field for the information in question.

Describing What Is Novel

In this specification we strive to only describe what is novel. We omit details of processes and functions where the steps are obvious to those skilled in the art.

### Contents

Part 1 Core Processes of the System

1.0 Introduction

1.1 Definitions and General Elements

1.2 Advertiser Process

1.3 Recipient Process

1.4 Inspector Process

1.5 Payment Processes

1.6 Report Processes

1.7 Ad Submission Processes (not essential)

Part 2 Embodiments for Various Media

2.0 Introduction

2.1 SPQ for Webpage, Audio and Video Ads

(An Embodiment for Paying Recipients to View Webpage Ads)

2.2 SPQ for Phone Calls

(An Embodiment for Paying Recipients to Call an Advertiser)

### 1.1 DEFINITIONS AND GENERAL ELEMENTS FOR THE CORE PROCESSES

Here we give definitions used in describing the core processes. We add definitions as necessary throughout this specification.

General Elements

SPQ is an online database system that includes memory means, input/output means, calculation means, and search means. SPQ includes front-end interfaces for enabling users to enter data objects (e.g., “offers”) and associated data. SPQ also includes front-end interfaces for enabling users to find and select data objects. The term front-end interface encompasses a wide variety of well-known mechanisms for entering and selecting data.

EVQ Offers

SPQ is a system for enabling advertisers to make EVQ offers to recipients. An EVQ offer is one where the advertisers agrees to pay the recipient an EV amount of money if the recipient meets the qualifications/conditions stated in the offer. In the context of this specification, we will also refer to EVQ offers as EVQ payment offers, pay-for-attention offers, payment offers or offers.

Three Kinds of Users

SPQ has three classes of users: advertisers, recipients and inspectors defined below. (Note: we omit system administrators because they are not generally involved with the novel features).

Advertiser (also called Addy).

User who makes a pay-for-attention offer (an EVQ offer) to qualified recipients.

Recipient (also called Reece).

User who finds and accepts EVQ offers from advertisers.

Qualified Recipient (also called Q-Reece).

User who is eligible to be paid according to the terms of an advertiser's EVQ offer.

Recipient Agent.

User who represents a recipient for the purpose of entering data for the recipient. For example, in certain implementations, a recipient might be represented by a telephone operator who enters ID and offer acceptance data into SPQ on behalf of a recipient. Note: we will consider a recipient agent to be the same as a recipient.

Advertiser Agent.

User who represents an advertiser for the purpose of entering data for the advertiser. For example, a service bureau that implements the inventive method may enable an operator to enter data for an advertiser.

Inspector (also called Vera).

User who verifies that the terms of an offer are met or not.

Three Key Data Sets

Generally speaking, SPQ makes use of three key data sets: offer data, offer selection (request) data and inspector report data—one for each kind of user. These are not the only data sets that SPQ uses, but they are the critical, minimal ones.

Offer Data.

This is the data an advertiser enters to create or identify a payment offer.

Offer Selection Data.

This is the data a recipient enters to find and accept an offer. (Note: in many implementations, a recipient will only have “press a button” in order to find and accept an offer and will not have to enter a set of data. In other implementations, the recipient will have to enter a code, and in others, a set of search criteria.)

Inspection Report Data.

This is the data an inspector enters to state whether or not a recipient has met the conditions of an offer.

Three Core Processes

SPQ has three “core processes”, one for each kind of user. These are not the only processes that SPQ can include for users but they are the minimal ones. Together these processes comprise the overall core process.

Advertiser (Create/Post Offer) Process. In this process, the advertiser submits the terms of her offer.

Recipient (Find/Accept Offer) Process. In this process, the recipient finds and accepts an offer, and SPQ processes the acceptance.

Inspector (Inspect/Verify Qualifications) Process. In this process, the inspector decides whether a winning recipient has met the conditions of an EVQ offer, and SPQ registers the inspector's decision.

SPQ will also include payment processes, which are integrated into the three core processes above. Payment processes vary depending upon the implementation, so we describe them separately for the sake of clarity (see Section 1.5).

### 1.2 ELEMENTS AND STEPS FOR THE ADVERTISER PROCESS

Introduction to the Advertiser Process

The advertiser process enables Addy to create and post an EVQ offer to recipients. There is no single process to be described since many variations are possible. Any overall advertiser process will include elements and steps for enabling the following actions:

1. Creating an advertiser account

2. Entering an offer

3. Making the offer accessible to recipients

4. Modifying the offer or making it inaccessible to recipients

5. Registering payment obligations of the advertiser.

In this section, we describe these elements and steps, focusing on the data elements that are necessary for entering an offer, as these involve the novel aspects of the invention.

1. Steps for Account Creation and Advertiser Authentication

As part of the overall advertiser process, it is necessary to authenticate the advertiser. So, SPQ includes steps for creating an advertiser account and authenticating an advertiser. We do not elaborate because such elements and steps are well known.

2. The Offer Data, the Fundamental Data Set/Object of SPQ

Since the advertiser process enables Addy to create and post an EVQ offer to recipients, it mainly consists of outputting an offer form to her and storing the data she fills into it. We will call this set of data the offer document, or the offer data or, simply, the offer.

SPQ stores the offer data that is entered into the form and timestamps the entry.

The data in the offer form serve three purposes:

They define the EVQ offer-that is, the contract offered by Addy to recipients.

They act as instructions that direct SPQ when the offer is accepted.

They enable the offer to be found by Addy and recipients.

Thus, the offer form data are the fundamental data set (data object) of the system, which is natural, given that most of the actions of the system revolve around handling and transacting offers.

The offer form is not necessarily a monolithic form in which all the offer data is entered at the same time. Offer form data can be entered through different forms, at different times—the sequence of entry and the presentation of forms will depend on the implementation. The concept of a single offer form is an abstraction. The point is to explain the data input fields that the system will present to advertisers—that is to say, the goal is to describe the types of data that the system inputs from an advertiser to create and store an offer that can be found and accepted by recipients.

In this section we describe the key data fields that an offer form includes. Some of these fields are always required; others depend on the implementation. Fields can be added, since an offer can include many conditions.

Field 1: Name Used by the Advertiser for the Offer Document

In order for an advertiser to find an offer that she has entered, it is useful to name that offer, just as naming any document is useful. Thus one field in an offer form is an offer name field enabling Addy to name the offer she enters so that she can find it.

Field 2: Name Used by the System to Identify an Offer Document

The system may also enable Addy to enter a separate name that is a system document name for identifying the offer. This kind of name may be useful in storing the offer in the system database and linking it to a recipient interface, as for example, associating the offer with a hyperlink.

Addy may not have to enter a system document name. The system may automatically apply a system document name to the set of data comprising the offer.

Whether a system document name is used or not depends on the implementation.

Field 3: Data for Enabling Recipients to Find an Offer

An offer is meant to be found and accepted by recipients. Thus, the advertiser process will include a step or steps by which Addy identifies the offer so that it can be associated with an input by the recipient—that is, so that a recipient who interfaces with the system can find and accept it.

Finding and accepting may be the same action or they may be separate actions, depending on the implementation. For example, SPQ may enable Reece to simply press a button to find and accept an offer. Reece does not even need to see the details of the offer. Alternatively, the system may enable Reece to find an offer and then press a separate button to signify that he accepts the offer.

There are many well-known methods for enabling a recipient to find and accept an offer. The method that is used will depend on the front-end implementation. We will not delve into the great variety of specific ways that can be employed because there is no novelty involved, but we will briefly discuss three general methods and explain how they may or may not be implemented in an offer form. We describe these different possibilities for the sake of explaining the breadth of applications of the system.

A. If the Offer Is Found Through a “Button” or the Equivalent

One way to enable Reece to find Addy's offer is for SPQ to be accessed through a button or link that, when selected, signifies that Reece has selected the offer. For example, a website for a health club might show the following hyperlink: Click on this link if you live in Denver and want to get paid $1 for reading about our health club. Likewise, the system might have an interactive voice response front-end that identifies the offer when Reece presses a particular button. For example, Press “1” if you live in Denver and want to get paid $1 to talk with one of our associates about our health club.

As another example, a health club might have special phone number that is connected to SPQ such that calling the number signifies that the recipient accepts an EVQ offer identified in the SPQ database by that phone number.

Where SPQ enables Reece to find and accept an offer without entering search criteria, but only through a “press-a-button” input, SPQ will require a step by which Addy enters the data that associates the offer with the “button”—i.e., with the recipient input. For example, if Reece finds the offer by selecting a URL, Addy may have to enter the URL.

B. If the Offer Is Found Through a Unique Name/Code

Another way that Reece can find an offer is through a name (code), which we will call a lookup name or lookup code because its purpose is to enable Reece to find the offer.

The lookup name is entered into a search mechanism, such as a search form, that is part of SPQ's front-end for recipients.

As an example of how such a code might be used, a print ad could have the following text, If you are about to join a health club, we'll pay you $1 to read about our club. Go to health club.com and enter “healthy” into the appropriate box. Or call 1-800-healthclub and enter “h-e-a-l-t-h-y” at the appropriate prompt.

Thus, the offer form can include a field for entering a lookup code to be associated with the offer. Alternatively, the advertiser process can include a separate step in which Addy associates the offer with a lookup code.

C. If the Offer Is Found Using Search Criteria

Another way to enable Reece to find an offer is by entering search criteria such as keywords and other parameters that can be used to identify the offer.

The offer form can include fields for entering data that identifies the offer. For example, the fields can enable Addy to enter search terms, or titles, or questions that can then be matched by Reece. The offer form can enable the offer to be identified by multiple terms. For example, Addy might identify her offer by the keywords health, health club, gym, and exercise studio. And Reece might enter exercise club into the SPQ search engine. And SPQ could then use this phrase to identify Addy's offer, which would then be presented to Reece. Identifying data—search criteria—are not restricted to terms and phrases, of course. They can include a wide variety of parameter relevant to an offer.

Special identifier fields may not necessary in the offer form because the offer conditions themselves (see below) can act as identifiers of the offer. For example, if an offer is made to Dentists who live in Denver, the SPQ search means may allow recipients to search for the term, dentist, and the city, Denver.

Indeed, in implementations of SPQ that enable recipients to use a search form for finding offers, the offer description and conditions will probably be the favored parameters for identifying and searching the offers (this method is the favored one were online markets are concerned).

We note that in certain implementations SPQ will be directory that contains different offers listed under the same search term. In this case, additional parameters will distinguish one offer from another.

While we have nothing novel to add where the finding of offers is concerned, we emphasize that SPQ can enable advertisers to identify their offers by entering a variety of descriptive data, and we do not mean to limit the possibilities in any way. Virtually any type of database search means can be incorporated into SPQ for finding offers.

Field 4: Data for Accessing the Advertising

In an EVQ offer Addy offers to pay Reece for his attention to her advertising.

There are three different ways that SPQ can be implemented regarding how Reece is exposed to Addy's advertising:

A. SPQ can play no role.

B. SPQ can provide Reece with the data necessary to receive Addy's advertising.

C. SPQ can store Addy's advertising and output it to Reece.

(Note: in all cases, SPQ does register that Reece was exposed to Addy's advertising or, at least, that Reece accepted the offer.)

A. If SPQ plays no role in exposing Reece to Addy's advertising then the offer form will not include a field for entering data that enables Reece to access Addy's advertising.

SPQ can be implemented so that it takes no role in the advertising process. For example, Addy can offer to pay Reece for calling Addy. Addy can show Reece her phone number outside the SPQ system, say, in a print advertisement. Reece can call and then, after the call, Reece or Addy can report the call to SPQ. As another example, if Addy enables Reece to accept her offer on her website by pressing a button on the site, SPQ does not have to a play direct role in Reece seeing Addy's ad. SPQ can simply be notified by the website that Reece has accepted Addy's offer.

As yet another example, SPQ Addy's advertising could show Reece a “proof-of-attention” code which Reece could enter into SPQ, signifying that Reece accepts the offer that corresponds to that code and that Reece has been exposed to the advertising. For instance, Addy can create offline print ads that include a proof-of-attention code that can be found by reading the ads. Reece can find the code and enter it into SPQ, proving that he has read the ads and that he accepts Addy's EVQ payment offer.

B. If SPQ provides Reece with data to access Addy's advertising then the offer firm will include a field for entering this data.

If SPQ connects Reece to Addy's advertisement, then SPQ is also a kind of “switchboard” (with novel payment functionality). We use the term “connect” loosely because SPQ will not necessarily maintain a connection between two parties. There are many kinds of advertising, so the means for “connecting” can differ widely. Naturally, in order for SPQ to play this role, SPQ will need to know how to find the advertising; it will need data for enabling Reece to access the advertising. As an example, Addy can enter a URL for locating her webpage or video advertisement. As another example, Addy can enter her telephone number for placing a call to her. Therefore, SPQ's offer form can include a field for entering the data necessary for enabling Reece to access Addy's advertising. Depending on the implementation, SPQ will also include well-known means for using the data to enable Reece to access Addy's advertising.

C. If SPQ stores an advertising message and outputs it to Reece then the offer form may or may not include a field for entering data for accessing the advertising.

As discussed, SPQ may enable Addy to enter her ad into the system. For example, SPQ may enable her to enter a text ad into the system, which is outputted to Reece when she accepts Addy's EVQ offer. In this case, the system may automatically associate the text ad with the offer data. The same goes if the ad is an audio or video ad. In most implementations, if the system includes means for entering an ad into the system, it will also include means for automatically associating the ad with the corresponding offer data. However, in certain implementations, the offer form may include a field in which Addy states the name or location of the ad within SPQ so that SPQ can find and output it.

Field 5: Amount of EV Payment

Through SPQ, an advertiser offers to pay recipients by the EV payment method-by an EV payment bet, that is. Accordingly, the offer form includes a field for stating the EV payment due to a recipient who accepts the EVQ offer and meets the offer conditions.

The payoff of the EV payment bet can be a static amount, such as $1,000. Or, the payoff amount can be determined by a payoff multiple of the EV payment, such as, 1000×. (Note, it is desirable in certain implementations for the payoff to combine both methods, such that the recipient must win two EV payment bets to receive the payoff.)

The payoff can be standard, or the offer form can include a field for enabling Addy to specify the payoff amount or the payoff multiple.

It is also possible for SPQ to enable recipients to set the payoff.

(For simplicity, will assume that the payoff amount and payoff multiple are standard.)

Field 6: Time Period for the Notification of Winning

In between acceptance of an offer and the notification of winning, the system must perform a random number selection to determine if Reece has won. When this process takes place depends upon on time of notification, but the exact timing will depend upon the implementation. For example, if the time of notification is 14 days after acceptance, the random number selection can take place any time from the moment of acceptance to the moment just before a winning notification is made.

Winners of EV payment bets need to be notified that they have won. The time period from acceptance of an EVQ offer to the notification of winning depends upon the implementation. The offer form can include a field for enabling Addy to specify when a winning recipient is notified. Alternatively, this field is omitted and the time period is set by default, or by a system rule that is standard.

Another important possibility is to enable Reece to determine when he is notified. The system can enable Reece to set the time period, or request that the random number selection be initiated and notification be made.

Field 7: EVQ Offer Conditions

The offer form can also include fields for defining the target to be paid, that is, for stating the conditions that Reece must meet in order to be paid.

The system can enable Addy to define the conditions using standard elements, but these are far too varied to describe here. Continuing applications will give more detail. Suffice to say that there are innumerable ways of describing a qualified (a target) recipient.

Conditions encompass not only the qualifications of a recipient but also other kinds of things, such as the kind of attention that a recipient must pay to an ad, and the time period of the EVQ offer. These are “boilerplate conditions” that can be part of any offer. Below we give just two such conditions that apply to most pay-for-attention offers.

Multiple Acceptances Condition

The offer form can include a field for specifying how many times Reece can accept a payment offer. Various conditions are possible. For example, a one-time-only condition is possible. A variation enables Reece to accept an offer multiple times but to only be able to collect on one of those times. We do not delve into the possibilities because they are too various. Suffice to say that the offer form can enable Addy to select from standard conditions concerning how many times Reece is permitted to accept an offer. In certain implementations, such a condition can be enforced by SPQ in the recipient process.

Attention Conditions

The offer form can include a field for specifying the kind and amount of attention that Reece must pay. In certain cases, this condition can be enforced by SPQ in the recipient process. For example, a condition might be that Reece has to listen to a sales message over the phone for at least 60 seconds. If Reece does not pay that much attention, SPQ may be able to detect that fact and nullify the offer. In other cases, only an inspector can verify whether the condition has been met. A variety of inspection possibilities exist, which are beside the point here. Suffice to say that the attention requirements can be stated in the offer form (alternatively, they can be stated outside the system). We should also note that there might be no enforceable attention condition. For example, Reece may be paid to look at a webpage. As long as SPQ registers that Reece has selected a hyperlink for the webpage, that selection may suffice to accept and fulfill the EVQ contract. Reece may not even glance at the page, and in fact the page may not even be successfully transmitted to Reece (as happens sometimes with webpages).

Note: Regarding Text of Full Offer

The offer form can also include a field in which Addy can put the full text, or a link to the full text, of her EVQ offer. This feature is useful so that an inspector can read the all the terms of the offer to determine whether or not Reece has met the terms. It is also necessary in cases where SPQ makes it possible to for Reece to look up the full text of an offer. For example, Reece might see an EVQ offer in a magazine ad and may use the front-end of SPQ to accept the offer. While doing this he might want to see the full text of the offer, which may not have been spelled out in the magazine ad.

Important Aside: Terms and Conditions Can Be Outside the System

Some or all of the terms and conditions of an offer may be stated outside of the system. In fact, none of the conditions has to be stated by an advertiser in an offer form. Technically speaking, they can all be standard conditions or conditions set outside the system, and understood by advertisers and recipients.

In this case, where the conditions are not stated in the offer form, they still have to be identified by the system so that accepted offers can be processed. Thus, the SPQ offer form will at least have a field enabling Addy to identify the offer, wherever it may reside.

Each individual term or condition given above can be stated outside the system and can be associated simply with the name of an offer, and hence does not need to be specified in an offer form. Thus, the fields of an offer form depend on the implementation.

Field 8: Controls

The offer form can also include fields or commands for controlling the presentation of the offer to recipients. These include:

An on/off command-that is, a suspend/reactivate command-that causes the offer to be shown or not to recipients.

A budget field stating that an offer is to be suspended after a specified number of acceptances or after a specified amount of money has been spent by the advertiser.

An expiration field that signifies that an offer is to expire at a given time.

3. Steps for Making the Offer Accessible to Recipients

As discussed above, SPQ can enable Addy to identify her offer so that it can be associated with a data input by Reece. If SPQ enables Reece to find/select/accept Addy's offer though a button or other such input, then SPQ will also include a step by which Addy associates her offer with the button, as for example, enabling her to associate a hyperlink with the offer. The possibilities are wide, depending on the interface being used, and the options are well known.

The other general approach is to enable Reece to find the offer through search means. If search means are employed, then Addy effectively takes the step of making her offer accessible by entering the search terms into SPQ.

If SPQ enables Reece to find an offer by search means, SPQ can also enable him to see the offer, or part of the offer, and then enter a separate input—such as pressing a button—to accept the offer.

Alternatively, simply arriving at a page that has the ad message can constitute acceptance of the offer. The details of what constitutes and acceptance can vary widely. To repeat, the steps involved are well known and need no elaboration.

4. Steps for Modifying or Deleting an Offer

As discussed, the advertiser process consists mainly of steps for enabling Addy to fill in an offer form. Naturally, the advertiser process will also include steps for enabling Addy to find a stored offer and to modify or delete it. These steps are well known and need no elaboration.

5. Steps for Enabling Payment by an Advertiser

Transferring actual payments may or may not be part of SPQ's functionality.

SPQ may simply register obligations by advertisers to qualified recipients. It is then up to the advertisers to make actual payment. In other words, SPQ can simply be an accounting machine that does not actually transact funds, but merely states how much is owed by an advertiser and to whom it is owed.

Alternatively, SPQ can take funds from an advertiser and distribute these, as is called for in the recipient process. In this case, the advertiser process will also include well-known steps for creating an advertiser debit account or credit account. In this case, SPQ will also include steps for accepting payment through well-known methods for accepting money through a variety of payment vehicles.

In the section on payment processes, we describe functionality for transacting actual payments from advertisers to recipients, but we recognize that SPQ can be implemented without this functionality.

### 1.3 ELEMENTS AND STEPS FOR THE RECIPIENT PROCESS

Introduction

Whereas the advertiser process mainly involves storing data defining an EVQ offer, the recipient process involves what SPQ does when a recipient finds an offer and accepts it.

Front-end Options for Enabling a Recipient to Find an Offer

As discussed, SPQ can have one or more front-end interfaces that enable recipients to find offers. In this section we are not concerned with interfaces, just with the key steps of the recipient process. We will assume that Reece has used the SPQ front-end and entered a simple command or search criteria to enable SPQ to find an offer.

Overview of the Key Steps of the Recipient Process

Below we give the key steps SPQ executes in the recipient process and we define the data elements needed. (We note that some of the steps can be executed in a different order than the one presented, depending on the implementation. Those skilled in the art will readily see where the sequence of steps can be changed.) The steps are as follows:

1. Register the recipient's identity.

2. Find an EVQ offer in response to the recipient's input.

3. Register acceptance of the offer (register that the recipient has been exposed to the associated advertising or has taken the necessary steps to be exposed).

4. Possibly, “connect” the recipient with the advertising or output the advertising.

5. Possibly verify that attention is paid to the advertising.

6. Apply the rule in effect regarding multiple acceptances.

7. Execute the EV payment bet specified in the offer.

8. Record the results of the EV payment bet.

9. If the acceptor has won the bet:

a. Inform him that he has won,

b. Receive and register the acceptor's claim to be paid the payoff,

c. Generate statistics about how many winners were also claimants,

d. Pass the claim to the inspector process.

We elaborate on these steps below. (We discuss payment steps in Section 1.5.)

1. Register the Recipient's Identity.

As part of the recipient process, SPQ must identify the recipient so that he can be paid in the event that he wins the right to collect the payoff.

Registering Reece's identity is also necessary so that duplicate acceptances of an offer can be purged, depending on the conditions governing multiple acceptances. And, Reece must be uniquely and legally identified so that he cannot successfully use multiple identities. That is to say, if he collects a payoff, the system needs to credit the payment to his legal name, a unique name.

Reece can be identified before he enters search criteria into SPQ, as is the case when Reece logs on to SPQ and then begins searching. SPQ will have identified him before the search. Alternatively, SPQ can identify him after he has entered search criteria and SPQ has presented an offer to him. In this case, SPQ can present a form for entering his ID data after he has accepted an offer. The exact sequence of registering ID data depends on the implementation. SPQ can incorporate the gamut of methods used to uniquely identify users of a system, and these need no elaboration.

2. Find the Offer in Response to the Recipient's Input.

SPQ finds the offer that corresponds to the command or search criteria Reece has entered.

3. Register the Acceptance of the Offer.

How SPQ enables Reece to accept an EVQ offer depends on the implementation. There are many possibilities and it is not possible to state a general rule to cover all the ways it is possible to configure a system to register the acceptance of a pay-for-attention offer.

In general SPQ registers an acceptance when it registers that the recipient has entered a command to be exposed to an advertising message or when it registers that the recipient has been exposed to an advertising message. We give some examples to illustrate.

Reece might arrive at a webpage and may signify acceptance by pressing a button that launches a separate webpage (or audio or video) ad.

Or Reece may enter search criteria into a search form and then SPQ may present him with an offer, which he can then accept.

Or the search criteria might lead to an ad being output to him, which could signify acceptance of the offer. Indeed, requesting a page with multiple, distinct messages may signify acceptance of multiple offers—an acceptance for each message. For example, SPQ may output a list of classified ads, each ad signifying a different offer from a different advertiser (we will delve into this possibility in a future specification).

Or Reece might call Addy through a telephone switch that reports to SPQ that Reece called Addy.

Or Reece might call Addy and Addy might then enter into SPQ that Reece called.

Or, SPQ might output an ad to Reece by email and register the sending of the email as acceptance of the offer. Or, the clicking of a link in the email might signify acceptance.

There are many possible interfaces and many possible acceptance sequences.

A recipient who accepts an offer will be called an acceptor.

An offer that is accepted will be called an EVQ contract.

The data object or file where SPQ registers Reece's acceptance will be called an acceptance record. SPQ creates an acceptance record per offer for an acceptor.

The acceptance record will include the following data (or pointers to the data):

the recipient's ID data,

the name of the offer (or other data for identifying),

the terms of the offer (as defined by the offer form data),

the time of acceptance.

If it is the acceptor's first time accepting the offer, the record will only contain data from this first acceptance. If Reece has accepted the offer before then SPQ will register and timestamp each additional acceptance in the record. Thus, an acceptance record can include multiple acceptances of the same offer. The validity of these acceptances will depend on the terms of the offer.

4. Possibly, Enable the Recipient to Access the Advertiser's Advertising or Possibly Output the Advertising.

As discussed in the description of the advertiser process, in certain implementations, one of SPQ's functions will be to “connect” Reece to Addy's advertising—to enable Reece to access Addy's advertising, that is. In such implementations, a key step in the recipient process will be making this connection (or providing the necessary data, such as an html link). Thus, SPQ will provide Reece with means for accessing Addy's advertising, and will enable Reece to access her advertising. These means will depend on the front-end that is being used (see Part 2, which supplies some examples).

Also as discussed, in certain implementations, SPQ may store Addy's advertising. In such implementations a key step in the recipient process will be to output the advertising.

5. Possibly Verify That Attention is Paid.

If SPQ connects Reece to Addy's advertising, SPQ may enforce the attention condition, if any, stipulated in the offer form. For example if calls are made through SPQ, SPQ might be able to enforce a time requirement per phone call.

Whether an attention condition is checked at this stage depends on the implementation. If so, and if Reece has violated the attention condition, then SPQ can alert him telling him that he is ineligible to collect on the payment.

If SPQ has a step for checking whether attention was paid, this step can come before the acceptance is registered. If the recipient has not paid adequate attention then the acceptance is not registered.

Alternatively, the registration of the acceptance can come first and then it can be canceled, if the recipient does not pay adequate attention.

There are two general ways to verify attention. In one way, SPQ registers what we will call verification data that can be understood by SPQ and that signifies whether Reece has paid attention to Addy's advertising or not. Verification data is a general idea that we cannot define precisely. It, too, depends upon the implementation.

For example, the phone switch that handles a call between Reece and Addy might send a signal telling SPQ that the phone call was long enough (or not long enough) to pass the attention condition of Addy's pay-the-caller offer.

As another example, Reece might be required to answer a question about Addy's advertising to prove that he indeed paid attention, in which case SPQ could include means for receiving and affirming a correct answer and rejecting an incorrect answer.

The second general way is to enable Reece to submit evidence of paying attention that cannot be processed automatically—that cannot be understood—by SPQ but that requires a human judge. In this case, SPQ stores the evidence in Reece's acceptance record and then, if Reece wins the EV payment bet, a human inspector determines whether Reece paid attention or not. For example, Reece can look at Addy's webpage and then answer the following question: “What is the main benefit of Addy's product according to this ad.” Reece can submit his answer by an email or by a form and SPQ can store the answer in the acceptance record, to be reviewed in the inspector process, if Reece wins the EV payment bet.

6. Apply the Rule in Effect Regarding Multiple Acceptances.

An EVQ offer will include a rule or rules—conditions—spelling out what happens if Reece accepts an offer multiple times. The rule can be a meta-rule of the system that applies to all EVQ offers or it can depend on the particular offer. A variety of rules are possible for determining whether an acceptance is valid.

In general, by valid we mean that an EV payment bet is executed for that acceptance to determine whether Reece wins the right to collect the payoff. We can think of an acceptance as a ticket that is valid or not in the sense that it gives the owner the right to participate in a random number selection that then determines whether the owner has the right to collect a payoff. An acceptance that can be canceled (“scratched”) depending on the rule that applies for multiple acceptances of an EVQ offer.

For example, one rule can be that the first acceptance is the valid one, and that any acceptance after that does not count. Another rule can be that the last acceptance is the one that counts. Another rule can be that if the EV of the EVQ offer changes, Reece can be eligible to collect on the acceptance of the offer with the highest EV. Another rule can be that Reece gets one valid acceptance per a period of time. Yet another rule can be that all the acceptances count but if Reece wins the payoff, the payoff is divided in some way by the number of acceptances. These rules are illustrations; all possible rules regarding multiple acceptances cannot, of course, be given.

SPQ may need to enforce whatever rule applies given the EVQ offer or the system meta-rules. Thus, SPQ will include a step for checking the acceptance record and, based upon the rule that is in effect, select only the acceptance that is valid for the next step of determining whether the acceptance is a winner. Alternatively, before registering an acceptance, SPQ can simply check whether it can be valid under the multiple acceptances rule that applies, and if the acceptance cannot be valid, then SPQ may not register it at all.

Note: The rules governing multiple acceptances can be subtle and it may be necessary to verify compliance in the inspector process where, in certain cases, it becomes evident that the recipient has tried to evade the rules. Hence, certain acceptance rules can be enforced before the EV payment bet is executed for a given acceptance and others can be enforced afterward, in the inspector process.

7. Execute the EV Payment Bet Specified by the Offer (Select a Random Number From a Range Dictated by the EV Payment and the Payoff or by the Payoff Multiple).

Once SPQ has determined that an acceptance is provisionally valid, it needs to determine whether Reece has won the right to collect the payoff—that is, whether Reece has won the EV payment bet. Thus, SPQ generates a random integer in the range dictated by the EV payment and the specified payoff or as dictated by the specified payoff multiple.

(In the case of a static payoff, an integer is selected in a range from 1-payoff, where the payoff is divided into integer units, and the recipient wins if the integer falls in the range 1-EV. In the case of a specified payoff multiple, N, where N is an integer, the probability of winning is 1/N, so an integer is selected in the range of 1-N and the recipient wins if a single, pre-determined number comes up, say, “1”. If N is not an integer, then the procedure is slightly modified, which needs no elaboration.)

(Note: a separate computer could do the random selection. If so, we would still consider it part of SPQ for our purposes of describing SPQ's core processes—which can be performed by one computer or linked computers that communicate with each other. (As stated in the advertiser discussion, the timing of the notification is determined by a standard rule, or by the time period specified by the advertiser in the offer form or, by the recipient's choice, depending on the implementation.)

8. Record the Results of the EV Payment Bet.

SPQ can record the winners and losers or it may only keep a record of the winners.

9a. If He has Won, Inform the Acceptor That He has Won.

If an acceptor wins an EV payment bet, SPQ notifies him, say, by sending him an email telling him that he has won the bet and that he must submit proof that he is qualified to collect the payoff—i.e., that he is a qualified recipient.

SPQ can inform the acceptor in other ways, e.g., if he uses an SPQ website, SPQ can identify him when he logs on and inform him of his win then. This method is more appropriate than email in certain situations.

(As stated in the advertiser discussion, the timing of the notification is determined by a standard rule, or by the time period specified by the advertiser in the offer form or, by the recipient's choice, depending on the implementation.)

At the notification stage SPQ can also output a claim form to the winner for entering proof of qualification data. The claim for can be output automatically to Reece or he could retrieve it by clicking on a link or similar selection means.

We cannot describe a universal claim form because of the variety of possible qualifications. However, one possible generic claim form may simply ask him whether he does indeed qualify to be paid the payoff, and if he responds “yes”, then an inspector may investigate the claim.

(A separate computer that is linked to SPQ may handle the alert process. As noted, distributing a function does not change the core process. The point is that when SPQ determines that Reece is a winner, it informs a sub-process for alerting him.)

We note that in certain implementations the claim steps may be obviated completely such that SPQ sends the case directly to an inspector upon determining that an acceptor has won. This option may be appropriate especially when the payoff is very large.

9b. Receive and Register the Acceptor's Claim.

The submission of qualification data, or the assertion that the acceptor is qualified, will be called a claim.

Those acceptors who submit claims will be called claimants.

If SPQ outputs a claim form then SPQ will receive a claim back from him through this form. When SPQ receives a claim this way, it registers the claim, which will include an ID number that associates the claim with the corresponding offer data and acceptance record data.

Another possibility is that Reece submits his claim by paper mail and that a system operator then logs the claim into the system. In this case, SPQ will still register the claim as if Reece himself entered the data.

9c. Generate Statistics About How Many Winners Were Also Claimants.

SPQ can periodically tabulate and output statistics that show the percentage of winners who were also claimants. Later, at the end of the inspector process, SPQ can also calculate how many claimants were deemed to be qualified recipients (those who collected their winnings). This data in particular is important for advertisers and it can be critical for developing discount rate statistics (discussed in Section 1.5).

9d. Pass the Claim to the Inspector Process.

After registering a claim, SPQ passes it to the inspector process (see Section 1.4).

Payment Steps in the Recipient Process

SPQ can register payment obligations in a few different ways. We describe possible payment processes in Section 1.5 but note that in most implementations, the payment registration steps take place in the recipient process if SPQ assumes payoff risk, which we believe will be most common in practice. The steps are described in Section 1.5 and their placement in the recipient process can easily be seen by those skilled in the art.

### 1.4 ELEMENTS AND STEPS FOR THE INSPECTOR PROCESS

At the end of the recipient process, if Reece has won the EV payment bet, he may submit a claim to collect the payoff stated in the offer he has accepted.

SPQ registers the claim and makes it available for an inspector (Vera) to examine. Vera's role is to verify whether Reece has fulfilled the conditions of the EVQ offer.

(We note that in certain implementations the inspection process can be automated.)

In the inspector process, SPQ can assign the claim to Vera. Or SPQ can enable Vera to find the claim and assign herself. Either way, Vera calls up this claim and, after examining the claim, enters a decision as to whether Reece has fulfilled the conditions of the offer. Thus, the inspector process includes the following elements and steps:

1. SPQ authenticates an inspector.

2. SPQ enables the inspector to retrieve a claim record, which includes the following data elements (defined in Section 1.3):

the offer form data, or a link to this data,

the recipient ID data, or a link to this data,

the acceptance data, or a link to this data,

the claim data, or a link to this data.

3. SPQ enables the inspector to call up an inspection report form, which includes fields for the following information:

a) The name of the inspector. This field is for registering which inspector is handling the claim. SPQ can automatically fill in this field using the inspector log-in.

b) The claim locator number. This field is for identifying the claim. SPQ can automatically fill in this field.

c) The decision. This field is for stating whether the claim is approved or rejected.

d) The explanation. If the claim is rejected, the inspector will usually need to explain why. Thus the inspection report form will include a field for supplying a text explanation of why the claim was rejected. The explanation can be a “form letter” explanation that can be selected by the inspector.

4. When the inspector enters a decision, SPQ stores and timestamps the inspection report and associates the report with the offer data and acceptance data for the recipient.

5. If the claim is rejected, SPQ executes the following steps:

notifies the recipient telling him of the rejection and, in the notice, includes the explanation stored in the explanation field of the inspection form.

If the claim is approved, SPQ can execute the payment transaction steps spelled out in Section 1.5. At minimum SPQ:

registers that the recipient is owed the payoff amount stated in the offer,

notifies the recipient telling him he has won and is owed the payoff,

sends notification of the payoff owed the recipient to a process (inside SPQ or outside SPQ) for paying the recipient or, simply sends notification to the advertiser that she owes the recipient the payoff.

Steps for Paying the Costs of the Inspection Process

Having Vera do an inspection costs money. The system can pay the costs in various ways and can assess a cost to advertisers and winning recipients.

We do not delve into the variety of payment schemes for defraying the costs of inspection. We assume that, like the other operations of the system, the costs must be defrayed and are paid by the advertisers and recipients, directly or indirectly.

However, we do note that inspection costs can be reduced by making claimants pay for the inspection, or pay a deposit to guarantee that their claims are valid. This measure will deter non-qualified recipients from making claims. Thus, an important step in the inspection process, in certain implementations, is to include a step for taking a payment/deposit from a claimant, when the claimant submits a claim.

### 1.5 REGISTERING ADVERTISER PAYMENTS

In Section 1.4, we said that when the inspector approves a claim, SPQ registers that the recipient is owed the payoff. However, we did not describe steps for actually paying the recipient and for getting payment from the advertiser.

SPQ is a system in which qualified recipients (Q-recipients) are paid through EVPM bets, meaning that the amounts actually paid are payoff amounts that may be quite large. How SPQ enables payoff payments to be transacted from advertisers to Q-recipients depends on whether the advertiser assumes the payoff risk in the EVPM bets or whether SPQ assumes the risk. We discuss these possibilities below.

Note: In all cases below, if SPQ collects payment from advertisers, SPQ will include well-known debit and/or credit account processes. Further, SPQ will include well-known mechanisms for accepting payment and for notifying an advertiser when her account has a low balance or an overdue balance. Further, SPQ will include well-known mechanisms for suspending an advertiser's offer when her balance has fallen below a threshold.

Case 1. Advertiser Assumes the Risk in the EVPM Bets

If the advertiser assumes the payoff risk, SPQ does not necessarily have to collect payment from her. SPQ can be an accounting machine in the sense that it registers payment obligations but does not transfer actual payment.

In this case, SPQ includes steps for notifying advertisers of their payment obligations and for notifying winning Q-recipients that they are owed the relevant payoff amount from a given advertiser.

For example, assume that IBM is paying recipients to view a commercial, and assume that Reece wins $10,000 in an EVPM bet based on this offer and, assume that Reece turns out to be a Q-recipient. Then, SPQ may simply notify Reece that IBM owes him $10,000 and will notify IBM that it owes Reece $10,000.

Alternatively, SPQ can include means for transferring payoffs from advertisers to winning Q-recipients. These means include steps for:

establishing a debit (or credit) account for an advertiser,

receiving funds into in this account and,

transferring a payoff from an advertiser account to a Q-recipient.

Case 2. SPQ Assumes the Risk in the EVPM Bets

If SPQ assumes the payoff risk, it will include means discussed above for establishing an advertiser payment account. Each time a recipient validly accepts an advertiser's offer, SPQ will deduct money from the advertiser's payment (debit) account and transfer it into an SPQ account, and from that SPQ account, the system will pay recipients.

But the process is more complicated than that; it is different from a conventional payment transfer system. The problem is that Addy is offering EV payments only to Q-recipients, but recipients who accept her offer will include Q-recipients and non-qualified recipients.

Assume that Addy offers Q-recipients $1 to call her flower shop. Now, assume that 2,000 recipients accept her offer.

How much does Addy owe SPQ? If she pays $1 per acceptance of her offer, that is not fair because she is only supposed to pay for Q-recipients. She does not know, and SPQ does not know, what percentage of acceptors were Q-recipients.

SPQ cannot know if a particular acceptor is a Q-recipient unless the uncertainty is resolved by the acceptor winning an EV payment bet.

Therefore, to compensate for non-qualified acceptors, SPQ must apply a discount factor to the EV amount that Addy offers to Q-recipients. This discount factor is applied to each valid acceptance. Each time a recipient accepts her offer, Addy would not owe SPQ the full amount of the EV payment stated in the offer, but a discounted rate. For example, if the EV amount offered to Q-recipients is $1 and the discount factor is 10%, then SPQ registers that Addy owes 10 cents per valid acceptance.

The goal in a discount factor is to represent the percentage of acceptors who are Q-recipients. To arrive at a fair discount factor, the general idea is to gather statistics on what percentage of acceptors are Q-recipients.

SPQ may include one or more formulas to determine the discount factor for a given advertiser and the advertiser's offer. The formulas will use data on how many acceptors convert into winning Q-recipients (how many winning acceptors are Q-recipients). These statistics can be gathered from the responses to offers within SPQ that are similar to Addy's offer. SPQ can feed this response data into the discount formula(s).

Other methods, such as survey methods can be used as well to yield discount factor data to be fed into discount formulas as well.

The point here is that if SPQ assumes the payoff risk it will include:

a discount formula (or formulas) for arriving at a discount factor, to be applied to the EV amount that is offered in an EVQ offer.

(Alternatively, in certain implementations, SPQ will not include a discount formula, but will include means for enabling a system administrator to enter a discount factor into the system.)

Further, in the recipient process, when a recipient accepts an offer, SPQ will:

apply the appropriate discount factor to the EV payment,

deduct the resulting amount from the advertiser's debit account,

transfer the amount to an SPQ account that is used to pay winning Q-recipients.

Further, in the inspector process, when an the inspector approves an acceptor's claim, SPQ will:

register that the acceptor is owed the payoff from the SPQ account that is used to pay winning Q-recipients.

Case 3. SPQ Enables the Advertiser to Choose to Take the Risk in EVPM Bets

SPQ can enable Addy to choose whether or not to assume the payoff risk. The system would simply include both kinds of payment processes discussed above. In this case, SPQ could enable Addy to check a box in the process of establishing her account in which she signifies that she will take the payoff risk in all payment offers to recipients. Alternatively, the SPQ offer form can include a box where Addy signifies that she will take the payoff risk for the particular offer.

### 1.6 PRODUCING ADVERTISER REPORTS

A process for producing reports for advertisers is not strictly necessary for the minimal operation of SPQ. Yet, it is so useful that we note, here in Part 1, that SPQ will include steps for enabling Addy to view:

a) how many unique recipients accepted her offer,

b) possibly, the identities of those recipients,

c) how many of those recipients won the EVPM bets,

d) how many of the winners turned out to be qualified recipients,

e) how much she has spent on EVQ offers (see Section 1.5).

### 1.7 ENTERING AN AD

As noted in the discussion of the advertiser process and the recipient process, SPQ may include functionality of storing and outputting ads. This kind of functionality is well known. There are certain implementations of SPQ in which having an advertiser enter an ad, and having SPQ output that ad to recipients, is integral to the total system, and does create a novel whole.

How SPQ enables advertisers to enter ads depends on the implementation and needs no elaboration. Entering and storing an ad can be an additional step in the advertiser process, or it can be a separate process done separately from entering an offer. If SPQ enables Addy to enter an ad into the system, it will require well-known means for associating the ad with her EVQ offer, and for enabling Reece to output the ad upon accepting the offer.

### PART 2

### EMBODIMENTS FOR VARIOUS MEDIA

### 2.0 INTRODUCTION TO PART 2

Problem to Be Solved

How to implement SPQ to suit different kinds of attention-different kinds of media?

Solution

The core process can be adapted to different advertising media. The specific solutions will depend upon the specific kind of advertising and media involved. In this Part we describe embodiments for adapting the core process to different kinds of advertising.

Organization of this Section

For convenience, we will divide advertising into two general, imprecise types:

(1) one-way advertising (webpage, audio, video ads and email ads)

(2) two-way “conversation” advertising (phone calls and meetings).

For each of both of these types, multiple embodiments can be constructed. We cannot be exhaustive in describing these embodiments. The key differences between embodiments in the advertiser process have to do with methods for linking ads to offers (and for entering ads, if SPQ stores and outputs ads). The key differences in the recipient process revolve around three sub-processes:

a) registering the recipient's identity,

b) exposing the recipient to the message, which may or may not involve SPQ,

c) enforcing the recipient's attention, which may or may not involve SPQ.

Assumptions for Visualizing the Invention

For the sake of concreteness in visualizing the invention, we will imagine that SPQ is used by multiple advertisers to post EVQ offers.

We can further imagine that the request interface enables Reece to find an offer by pressing a button. In this case, the pressing of the button would correspond to an offer ID that would then be communicated to the SPQ database to identify a specific offer.

Or, we can imagine that recipients identify an offer by entering a code into an SPQ search interface. For example, IBM may state in a print ad, Call 1-800-r-e-a-l-b-u-y and enter “I-B-M” at the appropriate prompt in order to get paid $2 to talk to one of our representatives. In this case, the code I-B-M would correspond to an offer that IBM has entered into SPQ in the advertiser process.

The general idea is that the central database can serve a variety of front-ends that are used to interface with recipients. When we describe embodiments, we will strive to not repeat the description of Part 1. We will often recap what was said in Part 1, for the sake of clarity, but will try to add matter only where necessary. Where we say, “remains the same”, we will mean that we have nothing to add to what was explained in Part 1. (Note: we will only describe two embodiments in this specification, but will may add to these in a later, continuing application.)

Contents of this Part

Section 2.1 An SPQ embodiment for paying recipients to view webpage ads

Section 2.2 An SPQ embodiment for paying recipients to call an advertiser

### 2.1 SPQ FOR WEBPAGE, AUDIO AND VIDEO ADS

### 2.10 Introduction to Section 2.1

Problems

How to pay a qualified recipient for paying attention to a webpage ad? Similarly, how to pay a qualified recipient for paying attention to an audio or video ad?

Solutions

Embodiments of SPQ's core processes can enable advertisers to pay qualified recipients for paying attention to webpage ads. In this section we describe one basic embodiment and features that can be added to it, as follows:

2.11 An SPQ for Webpage Ads

2.12 Features for Using Multiple Websites as Front-ends for Recipients

2.13 Attention Enforcement Features

### 2.11 AN SPQ for WEBPAGE ADS

Scenario

In this sub-section, we describe how the core processes are implemented as a directory system of EVQ offers that enables Q-recipients to be paid for viewing webpage ads. As an example of how this system might be used, we might imagine that a advertiser shows the lookup code in print ads much as she might show her phone number or her URL. Recipients could then go to the SPQ directory and enter the lookup code. (The directory could enable Reece to enter the advertiser's name, which could act as the lookup code. For example, she might show the code in a print ad, e.g., If you are going to join a health club in the next 20 days, go to realbuyers.net and enter “Bally's Health Club” into the search engine. Multiple advertisers could use such a directory. Note that SPQ-WA could also include search functions for enabling recipients to find lookup codes according to the name of the advertiser.)

So, we imagine that Reece finds an offer by entering a lookup code into this directory.

We will imagine that the system presents an offer to him by outputting a link that corresponds to the lookup code. When he selects the link, he accepts the corresponding EVQ offer and receives the corresponding ad. In other scenarios, simply entering the correct code may signify acceptance, and may cause the ad to be outputted to Reece.

We will call this embodiment an SPQ for Webpage Ads (SPQ-WA). This name is a misnomer since the methods of this embodiment extend to any recipient-launched, “one-way” message—such as, a webpage ad, an audio ad, a video ad, or even an email ad. We use a webpage as the example ad message for the sake of concreteness.

### 2.11a The Advertiser Process for SPQ-WA

Addy enters her offer into SPQ-WA through a website interface, using an offer form. Below, we describe the data she enters and how SPQ-WA uses it to enable Reece to accept her offer. We list the fields of an offer form, disclosed in Part 1, and add matter only as necessary.

Field 1: Name Used by the Advertiser for the Offer Document

Remains the same.

Field 2: Data for Enabling Recipients to Find an Offer

In the case of the SPQ-WA, under the scenario we have chosen, the data for finding Addy's offer is a lookup code specified by her. SPQ will check to insure that the code is unique to the system but it is up to Addy to decide what the code is.

Field 3: Data for Accessing the Advertising

In the case of an SPQ-WA, the data for accessing the advertising is a URL or an equivalent locator code. This address is presented as a link when Reece finds the offer. Reece can then select the link to receive the ad. (We do not mean to limit the application to URL's and corresponding webpages. The locator code enables an ad to be served to Reece from whatever ad server that the locator corresponds to—e.g., to an ad in an ad server in an interactive TV network.)

Field 4: Amount of EV Payment

Remains the same.

Field 5: Qualified Recipient Conditions

Remain the same. We elaborate in sub-section 2.12.

Field 6: Controls

Remain the same.

Additional Data Field for Entering a Description

The offer form may include a field for enabling Addy to enter data describing herself and her offer. This descriptive data is then presented by SPQ to Reece when he finds her offer. For example, the link may be accompanied by a title or blurb that previews the advertising message.

Steps for Enabling Payment by an Advertiser

Remain the same.

### 2.11b The Recipient Process for an SPQ-WA

Here we recap the steps of the core recipient process, adding matter where necessary to describe how the process is implemented for an SPQ-WA embodiment.

1. Register the Recipient's Identity.

If it is Reece's first time using SPQ-WA, SPQ will present him with a form for creating a user account. The form will include fields for entering a user ID and password and additional ID data specifying Reece's legal name. The goal is to have his log-on identity correspond to a single, legal identity so that he can be paid and so that he cannot use multiple identities.

If Reece has already set up a user account, the system registers him through his user ID, or through a cookie mechanism, or through any other equivalent mechanism. (Methods for identifying users need to explanation here.)

2. Find and Present the Offer.

Reece enters the lookup code for Addy's EVQ offer and SPQ-FVR finds the offer and presents it as a link to be selected.

We noted in the discussion of the offer form above that SPQ-WA may enable Addy to enter a description of herself and her offer. If so, the link would be accompanied by text describing the offer and/or describing Addy.

3. Register Acceptance of the Offer

If Reece selects the link presented to him, he signifies acceptance of the offer. SPA registers the acceptance. Alternatively, it is possible that simply entering the lookup code will suffice as signifying acceptance of the offer. In this case, SPQ does not need to present a link to Reece.

4. Provide the Data to Serve the Advertiser's Ad to the Recipient (“Connect” the Recipient to the Advertiser's Advertising).

If Reece selects the link presented to him, it causes SPQ to provide the data to serve the corresponding ad to Reece (i.e., SPQ can provide a re-direct to Reece's browser so that the browser requests the ad). The ad will be served by a machine controlled by Addy or another party, as specified by the ad locator that Addy supplied in the advertiser process.

Alternatively, it is possible that simply entering the lookup code will suffice as a command by Reece to view the ad corresponding to the offer. In this case, SPQ does not need to present a link to Reece. SPQ will simply direct the ad to be served to Reece, as specified by the ad locator that Addy supplied in the advertiser process.

(We note that it is possible for SPQ to serve the ad. If SPQ serves the ad, it will also require means for enabling Addy to load the ad into an SPQ ad server. This functionality would be integrated into the advertiser process.)

5. Verify That Attention is Paid.

Remains the same.

6. Apply the Rule in Effect Regarding Multiple Acceptances.

Remains the same.

7. Select a Random Number from a Range Dictated by the EV Payment and the Payoff (or the Payoff Multiple).

Remains the same.

8. Record the Results of the Random Number Generation.

Remains the same.

9a. When the Time Requirement has Expired, Inform the Acceptor that He Has Won.

Remains the same.

9b. Receive and Register Claim.

Remains the same.

9c. Pass the Claim to the Inspector Process.

Remains the same.

Payment Steps in the Recipient Process

Remain the same. Steps for transacting payment between advertisers and recipients can take place in the recipient process, as described in Part 1.

### 2.11c The Inspector Process for an SPQ-WA

Remains the same.

### 2.11d Payment Processes for an SPQ-WA

Remain the same.

### 2.12 FEATURES FOR USING MULTIPLE, WEBSITES AS FRONT-ENDS FOR RECIPIENTS

SPQ-WA can also enable any properly configured website to be a front-end that recipients interact with. This embodiment is useful for an advertiser who wants to enable recipients to see and accept her EVQ offer at her website.

Advertisers still enter their offers through a central SPQ website while the recipients interface with the distributed websites.

In this scenario, SPQ includes means for receiving data from the front-end sites. This data set was described in previous sections. Accordingly, the front-end site will:

register Reece's' ID,

present Reece with a EVQ offer (and possibly enable him to find an offer),

register acceptance of the offer,

send the data it registers to the central SPQ-WA database.

The front-end site must be configured with a program for sending this data to the central SPQ-WA database, or it must direct the recipient to retrieve forms from SPQ that submit data directly to the SPQ-WA database.

(The data will be associated with the particular EVQ offer, of course). Correspondingly, the central database requires means for receiving this data from the front-end sites.

A front-end site can include database functionality such that it holds an ID record of Reece. Alternatively, the front-end site can send Reece to an SPQ webpage that enables Reece to enter his ID data. Likewise, rather than send a set of data to the SPQ database, the front-end site might just send Reece to a SPQ webpage that is identified with the particular EVQ offer that Addy wants Reece to accept. The SPQ webpage can then handle the necessary data registration. The point is that there are various well-known possibilities for implementing a front-end.

The key aspect, for our purposes, is that the essential processes of the SPQ-WA database do not change. The database simply needs functionality for receiving data from recipients for a selecting EVQ offers from distinct, distributed front-ends.

The utility of the system can be greatly enhanced by this functionality because SPQ's front-end can be a set of distributed websites and not just a single, central directory site.

### 2.13 ATTENTION ENFORCEMENT FEATURES

Where paying for attention is concerned, it is usually quite useful for Addy to be able to verify that Reece has actually viewed her ad. Where webpage and video ads are concerned, there are three basic attention verification methods:

(1) measuring the time that Reece has spent viewing the ad,

(2) requiring that Reece interact with the ad in a certain way,

(3) requiring that Reece answer questions about the ad.

These methods of verifying attention are well known. We discuss them briefly because attention verification features can be critical in a pay-for-attention system. The point, then, for our discussion is that SPQ-WA can include means for receiving attention verification data from the server that is serving the ad to Reece. This verification data will be keyed to the particular ad and corresponding EVQ offer.

The verification data will be sent based on the time he has spent viewing the ad, or Reece's interaction with the ad or, the answer Reece has provided, depending on the verification method that is used.

If SPQ-WA has the task of verifying attention automatically then the data will have to be “understandable” by SPQ. It can be a simple verification signal (a “recipient paid attention” signal, sent by the ad server) or a set of data that has to be checked by SPQ.

If SPQ verifies attention, it will cancel Reece's acceptance of an EVQ offer if it does not receive a signal or a set of data that shows Reece has paid adequate attention.

While we do not delve into particular methods for verifying Reece's interaction with an ad and how a corresponding verification signal can be sent to SPQ, we will briefly mention two general methods so that we can describe the mechanisms SPQ will include to enable Addy to use SPQ's attention verifying functionality.

One method applies where the ad server follows a custom SPQ protocol for sending verification data to SPQ. In this case, the offer form can include a field for enabling Addy to specify a standard attention condition, such as interacting with Addy's ad in a certain way. According to the protocol, the attention verification signal will indicate whether or not Reece has met this condition.

A second method is to enable Addy to enter a verification code into the offer form. In this method, we assume that when Reece views an ad, the ad gives him the opportunity to click on a link to indicate that he is viewing the ad. Selecting this link will cause the ad server to send a verification code to SPQ that is unique to the ad. Along with the code, the ad server can send the ad's address. Thus, when SPQ receives the code, it can check the offer data and match it with the ad's address and with the verification code. This data is not enough.

(Equivalent to selecting a “verification link”, the ad server can enable Reece to enter a verification code into a webform that submits the code to SPQ. The code could be hidden in the ad, so that Reece proves he has seen the ad because he has found and entered the code.)

In order for SPQ to verify that Reece has been viewing, SPQ must also receive Reece's ID back from the ad server. Therefore, we also assume that when SPQ enables Reece to be served the ad, it sends a code to the ad server to identify Reece. The ad server sends this recipient ID back to SPQ along with the verification code and the ad address. With these data, SPQ can register that Reece has fulfilled the attention condition.

Finally, there is another method of verifying attention, which is different and was discussed in Part 1. SPQ can enable recipients to provide answers to questions about an ad. The answers may be machine verifiable, in which case they are equivalent to the verification code, discussed above. But, if the answers can only be judged by a human, then SPQ stores the evidence—the answer(s)—as part of the acceptance record, and enables an inspector to judge the evidence only if the recipient wins the EV payment bet for the offer. That means that human inspection can be done cost-effectively. This method of attention verification is novel because it uses the system's probabilistic inspection process to enable human verification of a recipient's attention.

### 2.2 SPQ FOR PHONE CALLS

### 2.20 Introduction to Section 2.2

Problems to Be Solved

How to implement SPQ to pay a qualified recipient for calling an advertiser? And, how to pay a qualified recipient for taking a call from an advertiser?

Solutions

Different kinds of embodiments of SPQ can enable advertisers to pay Q-recipients for paying attention over the phone. In this section, we describe just one embodiment:

### 2.21 An SPQ Utilizing an Interactive Voice Response Phone Switch

Scenario

One way that SPQ can enable an advertiser to pay Q-recipients for calling is to have recipients call an interactive voice response (IVR) system linked to a phone switch that registers the recipients and routes calls to the advertiser.

By phone switch we mean to encompass a variety of switches/routers for registering a calling party, registering a receiving party, transmitting a call between the two parties and, registering the duration of a call. The channel or protocol for transmitting the call is irrelevant for our purposes. The concept of a “switch” for our purposes applies equally whether the network being used is a network that opens a dedicated circuit between two parties, or a network that uses a protocol, such as the TCP/IP, to transmit packets.

Under our IVR switch scenario, Addy enters her offer at an SPQ website that is the front-end for entering offers. The SPQ website then uploads the number to the switch. Her phone number then goes on a list of authorized numbers, maintained by the switch. These are the numbers that the switch will connect callers to.

Under this scenario, Reece can then accept Addy's offer using the front-end for recipients, which is an IVR system. For example, Addy could advertise her EVQ offer in a magazine ad that states, Are you are a Q-recipient? We'll pay you $2 to call us. Call 800-Realbuy and enter code #202-333-7777. 800-Realbuy in this situation would be the phone number for the IVR front-end that recipients would interact with.

SPQ's IVR front-end and phone switch register Reece's ID data, capture the code that he enters, and route the call to Addy's phone number.

In addition to completing the call, the phone switch registers the length of the call. Importantly, this data enables SPQ to enforce the attention condition that is implicit or explicit in Addy's offer—e.g., she might specify that Reece has to stay on the phone for 60 seconds or more in order to collect an EV payment.

The IVR front-end does not have to process the data it registers; it can simply send the data to the central SPQ database, which then executes the rest of the recipient process. In this sub-section, we will describe the steps that SPQ takes under this scenario.

We will call this embodiment SPQ Using an IVR Switch or the IVR Switch.

### 2.21a The Advertiser Process in which SPQ Uses an IVR switch

In the IVR Switch embodiment, Addy enters her offer into SPQ through a website interface, using an offer form. Below, we describe the data she enters and how SPQ uses it to enable Reece to accept her offer. We list the fields of an offer sheet form, disclosed in Part 1, and add descriptive matter only as necessary.

Field 1: Name Used by the Advertiser for the Offer Document

Remains the same.

Field 2: Data for Enabling Recipients to Find an Offer

In the case of an IVR switch embodiment, the data for finding and accepting Addy's offer is a lookup code specified by Addy that corresponds uniquely to an offer or offers from her. We will assume, for simplicity and user-friendliness, that the code is the phone number that she wants Reece to call.

In certain situations, Addy may have different EVQ offers that apply to the same phone number, and so, SPQ can enable her to distinguish between offers by adding an extra number to her phone number—e.g., 202-222-7777-1, 202-222-7777-2, and so on. (Addy's payment offer may vary depending on the amount that Reece spends. This kind of “multi-offer” does not affect the lookup code.)

Field 3: Data for Accessing the Advertising

In the case of an IVR switch, the data for accessing the advertising is the phone number that Addy wants Reece to call. (If the phone number does not also serve as the lookup code, then Addy must enter the phone number into a phone number field.)

The SPQ database must then send the number to the switch, which requires means for storing the number in a list of authorized numbers. The SPQ database must also be able to send a cancellation notice to the switch that causes a number to be canceled from the list of authorized numbers.

Field 4: Amount of EV Payment

Remains the same.

Field 5: Qualified Recipient Conditions

The discussion of these conditions remains the same but let us elaborate. Where paying for a Q-recipient to call, the key attention condition is time spent on the call. This time period may be standard or set by Addy. If Addy sets it, there will be a field for enabling her to do so. Another condition that is possible is a time-of-day condition, in which Addy specifies a certain time period for Reece to call. Like the duration-of-the-call condition, this condition can be verified in the recipient process.

Field 6: Controls

Remain the same.

Steps for Enabling Payment by an Advertiser

Remain the same.

### 2.21b The Recipient Process in which SPQ Uses an IVR Switch

Here we recap the steps of the core recipient process, adding matter where necessary to describing how the process is implemented for an IVR Switch embodiment.

1. Register the recipient's identity.

The exact method for identifying Reece depends upon the implementation.

An IVR system can identify a recipient by a personal identification number (PIN) or an equivalent (such as a voiceprint). In certain cases, the recipient's number, captured through automatic number identification, may serve as a recipient ID. We will use the term PIN to represent a variety of methods for identifying and authenticating Reece.

One goal for the operation of SPQ is to link a PIN with Reece's legal identity, so that he can be paid, and so that he cannot use multiple PIN's. Therefore, SPQ can require that Reece pre-register his legal identity and PIN at an SPQ website that lets Reece choose a PIN which SPQ then uploads to the IVR system. The IVR system stores the PIN in a list of authorized PIN's.

An alternative is to enable Reece to register his legal ID through the IVR system, if it is his first time using SPQ. SPQ can let him choose a PIN as if he was using a website. The IVR system can enable him to enter his full name and address and unique identifying data. A minimal amount of data may be necessary. For example, the IVR interface may enable Reece to enter just his social security number. His PIN can then be associated with this data so that if he wins a payoff, his PIN can be associated with a unique, legal ID.

Of course, another alternative for assigning a PIN is to enable Reece to call a human operator who enters Reece's ID data into SPQ and assigns Reece his PIN. Yet another alternative is to not associate a PIN with legal ID data, such as a social security number or a full name. It is possible to enable Reece to make up his own PIN and enter it via the IVR interface. The reason to use this method of identifying Reece is user-friendliness; Reece has to enter less data. This method is vulnerable to cheating in that Reece may register multiple identities. Still, it may be feasible to use such a method if SPQ includes other cheat detection processes, such as tests for detecting users who win an abnormal number of times. Therefore, just a PIN, determined by Reece, may suffice to identify Reece to the system.

2. Find the offer.

Reece enters the lookup code for Addy's EVQ offer. We assume that the lookup code is Addy's phone number. The IVR interface registers the number and sends it to the switch.

The switch checks to see if the phone number is on the list of authorized phone numbers.

If not, the call is canceled.

If the lookup code is recognized, the IVR interface registers the number and sends it to the switch to connect the call.

3. Connect the recipient to the advertiser's advertising.

The switch transmits the call between Reece's and Addy's numbers.

4. Register duration of the call.

The switch registers the time/date and duration of the call. This data enables SPQ to verify that Reece has paid enough attention to qualify for the EV payment Addy has offered and enables toll charges to be applied.

5. Send data to SPQ database.

The IVR system and switch send the following data to the SPQ central database (where the rest of the recipient process is executed):

a. Reece's PIN,

b. the lookup code (which we assume is Addy's phone number)

c. the duration of his call,

d. the time/date of the call.

(Note: if the IVR is also used to enter Reece's legal identity and assign a PIN, then the IVR system would also send this data to the SPQ central database.)

6. Possibly, register toll charges to the advertiser.

If SPQ routes calls such that there is a toll charge, SPQ can also assess a charge to be paid (in most cases) by Addy based on the duration of the call. The charge is registered to Addy's account, which is identified by her phone number.

7. Verify qualified recipient conditions, in particular, that attention is paid.

We assume that Reece must spend a threshold amount of time on the call to Addy's number in order to collect his EV payment. Addy may set the threshold as part of the terms of her EVQ offer, or the threshold may be standard. Thus, SPQ checks if the duration of the call is greater than the threshold. If it is not, SPQ does not register an acceptance.

If Addy sets a custom threshold then SPQ must identify the offer and compare the duration of Reece's call with her custom threshold. SPQ can identify her offer by the lookup code.

Another Q-recipient condition, discussed above, is that Reece must call during a certain period in the day, e.g., from 9 am-5 pm. Thus, if this condition applies SPQ can check whether Reece has met it as well. If he has not, SPQ does not register an acceptance.

8. If enough attention is paid, register an acceptance.

If the duration of the call is greater than the threshold required, SPQ registers the acceptance of Addy's offer in an acceptance record.

9. Apply the rule in effect regarding multiple acceptances.

Remains the same.

10. Execute the EV payment bet specified in the EVQ offer.

Remains the same.

11. Record the results of the EV payment bet.

Remains the same.

12. Inform the winning acceptor that he has won.

Since Reece accesses SPQ via a voice interface, one way that SPQ can enable Reece to find out whether he has won the EVPM bet is to enable him to call the IVR interface, enter his PIN and, select a menu option for checking results. The IVR system can then connect with the SPQ central database and report to him if he has any “wins” for any EVQ offers he has accepted. Alternatively, SPQ can include a visual web interface that enables him to do the same thing—i.e., enter his PIN (user ID and password) and select a command for checking the results of his EVPM bets—of his acceptances of the EVQ offers, that is.

13. Receive and register claim.

Remains the same.

14. Pass the claim to the inspector process.

Remains the same.

Payment Steps in the Recipient Process

Remain the same except for the addition, depending on the implementation, of assessing toll charges to advertisers. Where Reece accesses Addy by phone through the SPQ switch, toll charges will usually apply. If so, these charges need to be paid by someone. There are various ways to assess these charges to users. One way is to assess the charge to Addy. If so, SPQ will need to assess the charge as part of the recipient process, as discussed above.

### 2.21c The Inspector Process in which SPQ Uses an IVR Switch

Remains the same.

### 2.21d Payment Processes in which SPQ Uses an IVR Switch

The possible processes for transacting EV payments remain the same. Steps that may be added involve registering toll call charges, as discussed above.

### 2.21e Producing Advertiser Reports

Remains the same.

### Book II

### Methods and Systems for Paying and Qualifying Prospects

In this “Book II” we repeat much of what was said in the previous discussion. The material in Book II comes directly from provisional application of 18/08/99. It was written first, and forms the basis of the preceding specification. For the purpose of insuring priority and reducing confusion, we repeat the description of the provisional application of 18/08/99.

Focus Is on a System for Paying a Special Kind of Prospect, a “Realbuyer”

In the remainder of this specification we will focus on describing database systems that enable sellers to pay a special kind of prospect that we call a realbuyer. We focus on describing a system for paying realbuyers because we guess that it is the most important initial application of the general method above. Let us give some context first before defining a realbuyer.

In order for sellers to pay prospects meaningful amounts of money for their attention, there has to be a high probability that those prospects will buy. The goal is to enable sellers to pay for attention while not giving money away to low or zero probability prospects. The sellers need to be paying “genuine” prospects. The solution is a trick, a novel deal between a seller and a prospect. A prospect can only get paid if she produces a receipt proving that she bought the product being advertised. For example, if a seller offers to pay someone to read an ad about cookware, then the prospect must prove that she indeed bought cookware within a specified time period after she read the ad. We call such a prospect—one who actually buys—a realbuyer.

Thus, the invention that we will be describing in this specification is built around enabling this deal to take place between sellers and prospects. The deal is that a seller agrees to pay prospects for receiving sales messages if the prospects prove they intended to buy the product or service being advertised. Prospects prove they intended to buy by submitting a receipt (or other proof of purchase).

This qualifying condition is, itself, an important, novel idea. It is different than a rebate; it is a payment for attention, regardless of which seller a prospect buys from. The ability to pay only realbuyers can be a major innovation because, for the first time, it enables sellers to focus their marketing resources directly on the highest probability prospects.

What enables the realbuyer deal to work efficiently is the EVPM. Because prospects are paid by the EVPM, only when a prospect wins an EVPM bet does she produce a receipt. A human auditor can then authenticate the prospect and her purchase. Those prospects that did not actually buy cannot collect even if they win an EVPM bet.

Substitution of Terms

In Book II, we change terms from the preceding discussion. Advertiser becomes seller, recipient becomes prospect and qualified recipient becomes realbuyer (RB).

“Core Plus” Approach to the Specification

This specification describes multiple inventions all built around a set of core processes that enable sellers to pay for the attention of prospects who meet certain qualifications. In brief, these processes do the following:

enable sellers to make and post payment offers

enable prospects to find and accept those offers

enable sellers to verify the qualifications of the prospects

enable sellers to pay prospects who qualify.

By core processes we mean the sequences of steps that the system executes to achieve its minimum purpose, which is to enable sellers to offer to pay realbuyers for receiving sales messages. We describe these core processes in Part 1 of this specification.

Many features can be added to the core processes in order to make the system more useful for both sellers and prospects. Accordingly, this specification will take “core plus” approach in which the core is spelled out and then additional features are described.

Part 1: Describing the Core Processes as Implemented for a Variety of Media

Since there is not just one kind of “attention” or one kind of sales message, the system can enable sellers to pay for different kinds of attention and pay prospects for receiving different kinds of sales messages.

We will describe the core processes first without having any specific type of implementation in mind. But, as reduced to practice, the invention will need to have a front end and other features that are suitable to the kind of sales medium being used: webpage, video, phone call, and email. Thus, Part 1 will describe how the core processes can be implemented to suit a variety of media. In other words, we will describe several embodiments of the core processes as applied to different media.

Future Application: Describing a Pay-for-Placement Directory

Payment offers can be posted in a “non-competitive” directory whose purpose is simply to enable prospects to find and accept the offers. Another kind of system is a competitive, auction/directory—a pay for placement system—in which offers are presented according to the payment amount. In a future application we will describe this kind of auction system.

A future application will also describe a variety of useful features that can be added to the systems described in this specification. A host of improvements can be added to the elemental invention to make advertising more efficient for prospects and sellers, e.g., providing feedback to sellers, compiling histories on prospects, enforcing relevancy and preventing cheating.

### CONTENTS

Chapter 10: The Set of Core Processes

Introduction

Definitions

Seller Process

Prospect Process

Inspector Process

Payment Processes

Report Processes

Chapter 20: Conditions that Can Be Added to a

Minimal RB Offer

Purchase Amount Condition

Purchase Period Condition

Location of the Prospect Condition

Payment Vehicle Condition

Place of Purchase Condition

Who the Prospect Buys from Condition

Rebate Condition

Decisionmaker Condition

Chapter 30: Embodiments

Chapter 40: Additional Methods and Features

### CHAPTER 10

### ELEMENTS AND STEPS OF THE CORE PROCESSES OF THE INVENTION

### 10.0 INTRODUCTION TO CHAPTER 10

Problem to Be Solved

How can a seller pay only realbuyers for their attention?

Core Solution

In this chapter, our goal is to give a solution to the problem above. We will improve on this solution in later chapters but, this chapter lays out the foundation, the core design of our solution, which we call SPQ. As discussed, SPQ is a database system for enabling sellers to pay realbuyer prospects for their attention. That means SPQ:

enables sellers to create and post realbuyer payment offers

enables prospects to find and accept those offers

enables sellers to verify the qualifications of the prospects

enables sellers to pay prospects who qualify as realbuyers.

In other words, SPQ is a database system for creating and transacting a special kind of contract. The overall core process is as follows:

1. the system registers an expected value payment offer from a seller

2. the system enables a prospect to find and accept offer the offer

3. upon an acceptance, the system generates a random number in a range determined by the amount of the expected value payment

4. if the prospect wins the random number selection (the expected value payment bet, that is), the system outputs the winner's file to an inspector

5. system registers the inspector's decision as to whether the prospect adhered to the full terms of the payment offer

6a. if the decision is yes, then the system registers that the prospect is owed the payoff of the bet, and sends an email alert to the prospect

6b. if the decision is no, the system sends an email alert to the prospect telling him he is not eligible for the payoff.

In this chapter we flesh out these steps. We split the overall process into three sub-processes—one for the seller, one for the prospect and, one for the inspector.

SPQ will include a front-end or front-ends. We will give the core processes without having in mind any particular front-end. The front-ends will vary depending on the type of sales message, e.g., a webpage, a phone call, an email and so on. To illustrate we will discuss different sales messages and different front-ends, but we save a detailed discussion of these subjects for Chapter 30.

The system can be configured to enable a single seller to post offers to prospects. For example, a company can use a website as the front end of the system, enabling the seller to post offers and enabling prospects to see and accept the offers. Alternatively, the system can enable multiple sellers to post offers, e.g., through multiple websites.

The core processes may all be performed on a single machine controlled by a single party. Alternatively, they can be divided into sub-processes that can be executed by systems that are controlled by different parties, one system handing its product off to another. How the overall process is split up in practice does not concern us; it is the steps and the parts of the process that count. We will lay these out.

Section 10.1 gives definitions for this chapter.

Section 10.2 describes the elements and steps of the seller process.

Section 10.3 describes the elements and steps of the prospect process.

Section 10.4 describes the elements and steps of the inspector process.

Section 10.5 describes additional steps for enabling sellers to pay prospects.

Section 10.6 describes reports that the system can output to sellers.

### 10.1 DEFINITIONS FOR CORE PROCESSES

Here we give definitions used in describing the core processes. We add definitions as necessary throughout this specification.

Three Kinds of Users

SPQ has three classes of users: sellers, prospects and inspectors (we omit system administrators).

Seller (also called Sela). User who makes payment offers to prospects.

Prospect (also called Paul). User who finds and accepts payment offers from sellers.

Inspector (also called Vera). User who verifies that the terms of an offer are met.

Three Key Data Sets

SPQ makes use of three key data sets: offer sheet data, offer request data and inspector report data—one for each kind of user. These are not the only data sets that SPQ uses, but they are the critical, minimal ones.

Offer Sheet Data. This is the data a seller enters to create an offer.

Offer Request Data. This is the data a prospect enters to find and accept an offer.

Inspection Report Data. This is the data an inspector enters to state whether or not a prospect abided by the terms of the offer.

Three Core Processes

SPQ has three core processes, one for each kind of user. These are not the only processes that SPQ will include for users but they are the minimal ones. Together these processes comprise the overall core process from start (seller creates a payment offer) to finish (prospect gets paid).

Seller (Create/Post Offer) Process. In this process, the seller submits the terms of her offer.

Prospect (Find/Accept Offer) Process. In this process, the prospect finds and accepts an offer, and SPQ processes the acceptance.

Inspector (Verify Purchase) Process. In this process, the inspector renders her verdict as to whether actual payment should be made to a prospect.

Realbuyer Terms

Realbuyer Offer (RB offer). An offer to pay a prospect who has fulfilled certain conditions, most importantly, buying the product or service that is the subject of the offer.

Realbuyer (RB). A prospect who has fulfilled the conditions of an RB offer.

### 10.2 ELEMENTS AND STEPS FOR THE SELLER PROCESS

Steps for Account Creation and Seller Authentication

As part of the seller process, it is necessary to authenticate the seller. So, SPQ includes well-known steps for creating a seller account and authenticating a seller.

The Offer Sheet Data, the Fundamental Data Set/Object of SPQ

The seller process enables Sela to create and post an RB offer to prospects. As such, it mainly consists of outputting an offer sheet form to her and storing the data she fills into it. An offer sheet form will also be called an offer form or a blank offer sheet. The set of data filled into the offer form will be called an RB offer, an offer, or an offer document. SPQ stores the offer data that is entered into the form and timestamps the entry as well.

The data in the offer form serve two purposes. First, they define the RB offer—that is, the contract offered by Sela to prospects. Second, they act as instructions that direct SPQ when the offer is accepted. Thus, the offer sheet data is the fundamental data set (data object) of the system, which is natural, given that most of the actions of the system revolve around handling and transacting offers.

In this section we describe the key data fields that an offer sheet includes. Some of these fields are always required, others depend on the embodiment. Fields can be added, since an offer can include many conditions.

(Reminder: as noted in the Preface, “field” connotes one or more fields for named data.)

Field 1: Name Used by the Seller for the Offer Document

In order for a seller to find an offer that she has entered, it is useful to name that offer, just as naming any document is useful. Thus one field in an offer form is a document name field enabling Sela to name the offer she enters so that she can find it. SPQ will include means, of course, for enabling Sela to look up and modify any offer she has entered. (Prospects will not necessarily see the full offer document when they find an offer.)

Field 2: Data for Enabling Prospects to Find an Offer

In order to be accepted, an offer must first be found by a prospect. There are a few basic methods that can be employed to enable a prospect to find an offer. The method that is used will depend, of course, on the front-end that SPQ presents to prospects.

Below we will give three basic methods for finding an offer and explain in each case why the offer sheet will or will not include a field for enabling Sela to supply data for enabling Paul to find the offer.

A. If the Offer is Found Through a “Button” or the Equivalent

One way to enable Paul to find Sela's offer is for SPQ to be accessed through a button of some sort that, when pressed, signifies that Paul has selected the offer. For example, a website for a health club might show, Click this button if you want to get paid $1 for reading about our health club. Likewise, the system might have an interactive voice response front-end that identifies the offer when Paul presses a particular button. For example, Press “1” if you want to get paid $1 to talk with one of our associates about our health club. More simply, a health club might have special phone number that is connected to SPQ such that calling the number signifies that the prospect accepts a payment offer identified in the SPQ database by that number.

In such cases, the offer does not need any special name so that Paul can identify it, which means that the offer sheet does not need to include a name by which Paul finds the offer.

(In cases where prospects find the offer through a button, the SPQ front-end will include configuration means for enabling Sela to specify which offer corresponds to the button. She can identify the offer by its document name.)

B. If the Offer is Found Through a Unique Name/Code

Another way that Paul can find an offer is through a name (code), which we will call a lookup name or lookup code because its purpose is to enable Paul to find the offer.

The lookup name is entered into a search form that is part of SPQ's front-end and the offer would then be located. For example, a print ad could have the following text, If you are about to join a health club, we'll pay you $1 to read about our club. Go to healthclub.com and enter “healthy” into the appropriate box. Or call 1-800-healthclub and enter “9999” at the appropriate prompt.

In cases where a lookup name is used, the offer sheet will include a field for enabling Sela to supply the lookup name, which is then used by SPQ to enable Paul to find the offer.

In this scenario we assume that the name is unique in the sense that it identifies only one offer.

An alternative is a public directory system in which a name, such as a keyword, can correspond to multiple offers. We discuss that case just below.

C. If the Offer is Found Through Keywords or Natural Language

Another way to enable Paul to find an offer is through a keyword search or through a natural language search. This approach is the same as the lookup name approach above if SPQ uses an exact match algorithm for in its search function and if the keyword is associated only with Sela's offer. But it is possible for SPQ to be a public directory that contains different offers from different sellers listed under the same keyword.

Another possibility is that SPQ can include means for enabling Paul to find Sela's offer through a best match search function. (This way of identifying an offer is suited the case where SPQ is a directory of offers from multiple sellers.) In this case, it is useful to enable Sela to label the offer using multiple keywords and keyphrases. Thus, in this case, an offer sheet can include a field that enables Sela to supply a multiple keywords and phrases to label her offer. We might call this semantic material by the name indexing material or lookup material or matching material because the idea is that Sela supplies semantic material that can be used by SPQ to match a request by Paul. For example, Sela might identify her offer by the keywords health, health club, gym, and exercise studio. And Paul might enter exercise club into the SPQ search engine. And SPQ could then use this phrase to identify Sela's offer, which would then be presented to Paul.

Field 3: Data for Accessing the Advertising

In an RB offer Sela pays for Paul's attention to advertising. In certain implementations, SPQ will play no role in exposing Paul to Sela's advertising. For example, if Sela enables Paul to accept her RB offer on her website by pressing a button on the site, SPQ does not have to play any role in Paul seeing Sela's advertising. SPQ can be notified by the website that Paul has accepted Sela's offer, but that does not mean that SPQ connects Paul to the advertising. As another example, SPQ could enable Paul to enter a code into SPQ's search function, signifying that Paul accepts the offer that corresponds to that code. Again, SPQ does not have to play a role in whether Paul has been exposed to the advertising associated with that code.

Alternatively, in many implementations, a key function of SPQ will be to connect Paul to Sela's advertising. There are many kinds of advertising, so the means for connecting can differ. For example, SPQ can provide a hyperlink that Paul can select to view a webpage of Sela's. As another example, SPQ can provide a link that Paul can select to be connected by phone to Sela. Thus, SPQ can be a switchboard.

In order for SPQ to be a switchboard, SPQ will need to know how to find the advertising; it will need data for making the connection, enabling Paul to access the advertising, that is. As an example, Sela can enter a URL for locating her webpage or video advertisement. As another example, Sela can enter her telephone number for placing a call to her.

Therefore, SPQ's offer form can include a field for entering the data necessary for making the connection. SPQ can also include a field for enabling Sela to state what kind of connection is necessary, or that can be implied. SPQ will also include the means for using the data to enable Paul to access Sela's advertising (see Chapter 30).

Field 4: Amount of EV Payment

SPQ pays prospects by the expected value payment method (EVPM). Accordingly, the offer sheet includes a field for stating the EV payment due to a prospect who accepts the offer and adheres to the realbuyer conditions of the offer (see below).

The payoff amount can be standard, either a specified amount, such as $1,000, or a specified payoff multiple of the EV amount, say, 1000×. Or the offer sheet can include a field for enabling Sela to specify the payoff amount or the payoff multiple. (We will assume, for simplicity, that the payoff amount or payoff multiple is standard.)

Field 5: Realbuyer Conditions

The offer sheet will also include fields for defining a realbuyer.

Generally speaking, a realbuyer is someone who buys the product/service being advertised within a specified period of time after the offer has been accepted. Below we give just a few useful conditions, realizing that many others can be added.

Purchase Period (the time period in which the purchase must take place)

The offer sheet will include a field for specifying the purchase period. This figure, say 30 days, specifies how much time Paul has, after he has accepted the offer, to buy the product being advertised. For example, if he accepts an offer to be paid for reading an ad about a health club, then he must purchase a club membership within 30 days of accepting the offer.

Further, SPQ can enable Sela to set a beginning and ending time. For example, she may stipulate that Paul must buy between 10 days after he has searched and 60 days after he has searched. This feature can be useful for products that require a lead-time for purchase. If Sela requires that Paul buy at some period after he has searched she can reduce cheating by users who view her advertising, say, the day before they buy, simply to collect the EV payments, rather than because they are interested in buying from her.

Multiple Acceptances Condition

The offer sheet can include a field for specifying how many times Paul can accept a payment offer. Various conditions are possible. For example, a one-time-only condition is possible. A variation enables Paul to accept an offer multiple times but to only be able to collect on one of those times. We do not delve into the possibilities because they are distracting here. Suffice to say that the offer sheet can enable Sela to select from standard conditions concerning how many times Paul is permitted to accept an offer. In certain cases, such a condition can be enforced by SPQ in the prospect process.

Attention Conditions

The offer sheet can include a field for specifying the kind and amount of attention that Paul must pay. In certain cases, this condition can be enforced by SPQ in the prospect process. In others, only an inspector can verify whether the condition has been met. For example, a condition might be that Paul has to listen to a sales message over the phone for at least 60 seconds. If Paul does not pay that much attention, SPQ may be able to detect that fact and nullify the offer. A variety of inspection possibilities exist, which are beside the point here. Suffice to say that the attention requirements can be stated in the offer sheet (alternatively, they can be stated outside the system).

Text of Full Offer

The offer sheet can also include a field in which Sela can put the full text, or a link to the full text, of her payment offer. This feature is useful so that an inspector can read the all the terms of the offer to determine whether or not Paul has met the terms. It is also useful in cases where SPQ makes it possible to for Paul to look up the full text of an offer. For example, Paul might see an offer in a magazine ad and may use the front-end of SPQ to accept the offer. While doing this he might want to see the full text of the offer, which may not have been spelled out in the magazine ad.

Field 6: Controls

The offer sheet can also include fields for controlling the presentation of the offer to prospects. Some of these include:

A budget field that signifies that an offer is to be suspended or withdrawn after a specified number of acceptances.

An expiration field that signifies that an offer is to expire at a given time.

An on/off field that specifies whether the offer is to be posted or not (this field can be used to suspend an offer).

Aside: Terms and Conditions Can Be Standard

Some or all of the terms and conditions of an offer may be stated outside of the system. In fact, none of the conditions has to be stated by a seller in an offer sheet. Technically speaking, they can all be standard conditions, understood by sellers and prospects. In this case, where the terms are not stated in the offer sheet, they still will have to be entered as standard values into the system so that accepted offers can be processed. Completely standardized offers probably will not predominate in practice. However, each individual term or condition given above can be stated outside the system and can be associated simply with the name of an offer, and hence does not need to be specified in an offer sheet. Thus, the fields of an offer form depend on the implementation.

Steps for Modifying an Offer

As discussed, the seller process consists mainly of steps for enabling Sela to fill in an offer form. Naturally, the seller process will also include steps for enabling Sela to find an existing offer and to modify or delete it.

Additional Descriptive Material

The offer field may also include text and pictures that describe Sela's offer and Sela herself. This descriptive data can be used when the offer is presented to Paul.

Steps for Enabling Payment by a Seller

Transacting payment may or may not be part of SPQ. In this specification, we will assume that it is part of SPQ, while recognizing that SPQ can be designed without this functionality. SPQ may simply register obligations by sellers to realbuyers. It is then up to the sellers to make actual payment. In other words, SPQ can simply be an accounting machine that does not actually transact funds, but merely states how much is owed by a seller and to whom it is owed.

Alternatively, SPQ can take funds from a seller and distribute these, as is called for in the prospect process. In this case, the seller process will also include well-known steps for creating a seller debit account or credit account. In this case, SPQ will also include steps for accepting payment through a variety of well-known payment vehicles, i.e., paper check transfers can be automatically recorded, or manually recorded. (See Section 1.5.)

### 10.3 ELEMENTS AND STEPS FOR THE PROSPECT PROCESS

Whereas the seller process mainly involves storing data defining an RB offer, the prospect process involves what SPQ does when a prospect finds an offer and accepts it.

Front-end Options for Enabling a Prospect to Find an Offer

In order for Paul to find and accept an offer he must interface with SPQ. As discussed in the Preface, SPQ can have one or more front-end interfaces that enable prospects to find offers. In Section 1.3 we discussed some of these interface possibilities, and in Chapter 30 we will elaborate. In this section we are not concerned with interfaces, just with the key steps of the prospect process. We will assume that Paul has used the SPQ front-end and entered a command or search criteria to enable SPQ to find an offer.

While realizing that in certain implementations that the interface can be just a button, we will assume that Paul finds RB offers by entering search criteria into a search engine form. We will call the form an offer request form.

Below we give the key steps SPQ executes in the prospect process and we define the data elements needed as well. (We note that some of the steps can be executed in a different order than the one presented, depending on the implementation and embodiment. Those skilled in the art will readily see where the sequence of steps can be changed.)

1. Register the Prospect's Identity.

As part of the prospect process, SPQ must identify the prospect so that he can be paid in the event that he wins the right to collect the payoff.

Registering Paul's identity is also necessary so that duplicate acceptances of an offer can be purged, depending on the conditions governing multiple acceptances. And, Paul must be uniquely and legally identified so that he cannot successfully use multiple identities. That is to say, if he collects a payoff, the system needs to credit the payment to his legal name, a unique name.

Paul can be identified before he enters search criteria into SPQ, as is the case when Paul logs on to SPQ and then begins searching. SPQ will have identified him before the search. Alternatively, SPQ can identify him after he has entered search criteria and SPQ has presented an offer to him. In this case, SPQ can present a form for entering his ID data after he has accepted an offer. The exact sequence of registering ID data depends on the implementation.

2. Find the Offer.

SPQ finds the offer that corresponds to the command or search criteria Paul has entered.

3. Register the Acceptance of the Offer.

How SPQ enables Paul to accept an RB offer depends on the implementation. Simply arriving at a webpage and pressing a button may signify acceptance. Or Paul may enter search criteria into a search form and then SPQ may present him with an offer, which he can then accept. There are, of course, many interface possibilities.

A prospect who accepts an offer will be called an acceptor.

An offer that is accepted will be called an RB contract.

The data object or file where SPQ registers Paul's acceptance will be called an acceptance record. SPQ creates an acceptance record per offer for an acceptor.

If it is the acceptor's first time accepting the offer, the acceptance record will only contain data from this first acceptance. The record includes the prospect's ID data, the name (ID) of the offer, the terms of the offer (as defined in by the offer sheet data), and the time of acceptance. If Paul has accepted the offer before, then SPQ will note and timestamp each additional acceptance in the record.

It may be that the Sela's offer enables Paul to accept multiple times and get credit for one of those times. This feature can be useful if Paul is unsure when he is going to buy. For example, if he accepts an RB offer of $5 for looking at an ad for a piano, and he buys a piano 40 days after looking at the ad, then he is not eligible for payment if the expiration period is 30 days. So, he might want to accept the offer a second time, say, 20 days before he buys. The point is simply that an acceptance record can include multiple acceptances of the same offer. The validity of these acceptances will depend on the terms of the offer.

4. Possibly Connect the Prospect to the Seller's Advertising.

As discussed in the description of the seller process, in certain implementations, one of SPQ's functions will be to connect Paul to Sela's advertising. In such implementations, then, a key step in the prospect process will be making this connection. Thus, SPQ will provide Paul with means for accessing Sela's advertising, and will enable Paul to access her advertising. These means will depend on the front-end that is being used (see Chapter 30 for elaboration).

5. Possibly Verify that Attention is Paid.

If SPQ connects Paul to Sela's advertising, SPQ may enforce the attention condition, if any, stipulated in the offer sheet. For example if calls are made through SPQ, SPQ might be able to enforce a time requirement per phone call. Whether an attention condition is checked at this stage depends on the implementation. If so, and if Paul has violated the attention condition, then SPQ could send an alert telling him that he was ineligible to collect on the payment.

If SPQ has a step for checking whether attention was paid, this step can come before the acceptance is registered. If the prospect has not paid adequate attention then the acceptance is not registered. Alternatively, the registration of the acceptance can come first and then it can be canceled, if the prospect does not pay adequate attention.

6. Apply the Rule in Effect Regarding Multiple Acceptances.

An RB offer will include a rule or rules—conditions—spelling out what happens if Paul accepts an offer multiple times. The rule can be a meta-rule of the system that applies to all RB offers or it can depend on the particular offer. A variety of rules are possible for determining whether an acceptance is “live”.

By live we mean that a random number generation is performed for that acceptance to determine whether Paul wins the right to collect the payoff. We can think of an acceptance as a ticket that is live or not in the sense that it gives the owner the right to participate in a random number selection that then determines whether the owner has the right to collect a payoff. An acceptance that can be canceled (“scratched”) depending on the rule that applies for multiple acceptances of an RB offer.

For example, one rule can be that the first acceptance is the live one, and that any acceptance after that does not count. Another rule can be that the last acceptance is the one that counts. Another rule can be that if the EV of the RB offer changes, Paul can be eligible to collect on the acceptance of the offer with the highest EV. Another rule can be that Paul gets one live acceptance per a period of time, say, the time period in which he has to make a purchase. Yet another rule can be that all the acceptances count but if Paul wins the payoff, the payoff is divided by the number of acceptances.

SPQ needs to enforce whatever rule applies given the RB offer or the system meta-rules. Thus, SPQ will include a step for checking the acceptance record and, based upon the rule that is in effect, select only the acceptance that is live for the next step of determining whether the acceptance is a winner. Alternatively, before registering an acceptance, SPQ can simply check whether it can be live under the multiple acceptances rule that applies, and if the acceptance cannot be live, then SPQ may not register it at all.

(Note: The rules governing multiple acceptances can be subtle and it may be necessary to verify compliance in the inspector process where, in certain cases, it becomes evident that the prospect has tried to evade the rules. Hence, certain acceptance rules can be enforced before the random number generation is performed for a given acceptance and others can be enforced afterward, in the inspector process.)

7. Select a Random Number From a Range Dictated by the EV Payment and the Payoff or as Dictated by the Specified Payoff Multiple.

Once SPQ has determined that an acceptance is live, it needs to determine whether Paul has won the right to collect the payoff-that is, whether Paul has won the EV bet. Thus, SPQ generates a random integer in the range dictated by the EV payment and the specified payoff or as dictated by the specified payoff multiple, if a multiple is used.

(In the case of a specified payoff, an integer is selected in a range from 1-payoff, and the prospect wins if the integer falls in the range 1-EV. In the case of a specified payoff multiple, an integer is selected in the range of 1-multiple, and the prospect wins if a single, pre-determined number comes up, say, “1”.)

We will assume that the random number generation takes place after the time period for making a purchase has expired. But, the exact timing of the step depends on the implementation. There can be advantages to performing this step it at the time of the acceptance. Paul is not notified of the result, however, until the time period for making a purchase has expired.

(Note: a separate computer could do the random selection. If so, we would still consider it part of SPQ for our purposes of describing SPQ's core processes-which can be performed by one computer or linked computers that communicate with each other.)

8. Record the Results of the Random Number Generation.

SPQ can record the winners and losers or it may only keep a record of the winners.

9. When the Time Requirement has Expired, Inform the Acceptor that He Has Won.

After the time requirement for making a purchase has expired, SPQ sends an email alert telling a winning acceptor that he has won the random selection and that he must submit receipt data in order to collect his payoff. SPQ can inform the acceptor other ways, e.g., if he uses an SPQ website, SPQ can identify him when he logs on and inform him of his win then. This method is more appropriate than email in certain situations.

SPQ can also at this stage output a claim form to the winner for entering receipt data.

(Note: a separate computer that is linked to SPQ may handle the alert process. As noted, distributing a function does not change the core process. The point is that when SPQ determines that Paul is a winner, it informs a sub-process for alerting him.)

10. Receive and Register Claim.

The submission of receipt data will be called a claim.

Those acceptors who submit receipts will be called claimants.

If SPQ outputs a claim form when it alerts Paul that he has won, then SPQ will receive a claim back from him through this form. When SPQ receives a claim this way, it registers the claim, which will include an ID number that associates the claim with the corresponding offer sheet data and acceptance record data.

Another possibility is that Paul submits his receipt by paper mail and that a system operator then logs the claim into the system. In this case, SPQ will still register the claim as if Paul himself entered the data.

(Of course, Paul will not submit a claim if he has not made a purchase as stipulated by the conditions of the RB offer.)

11. Pass the Claim to the Inspector Process.

After registering a claim, SPQ passes it to the inspector process (see Section 1.4).

12. Generate Statistics About How Many Winners Were also Claimants.

SPQ can periodically tabulate and output statistics that show the percentage of winners who were also claimants.

Later, at the end of the inspector process, SPQ can also calculate how many claimants were deemed to be realbuyers (those who collected their winnings). This data in particular is important for sellers and it can be critical for developing discount rate statistics (discussed in Section 1.5).

Payment Steps in the Prospect Process

SPQ can register payment obligations in a few different ways. We describe possible payment processes in Section 1.5 but note that payment registration steps take place in the prospect process if SPQ assumes payoff risk, which we believe will be common in practice. The steps are described in Section 1.5 and their placement in the prospect process can easily be seen by those skilled in the art.

### 10.4 ELEMENTS AND STEPS FOR THE INSPECTOR PROCESS

At the end of the prospect process, Paul submits a claim to collect the payoff stated in the offer he has accepted. SPQ registers the claim and makes it available for an inspector (Vera) to examine. Vera's role is to verify whether Paul has fulfilled the conditions of the RB contract. In the inspector process, SPQ can assign the claim to Vera. Or SPQ can enable Vera to find the claim and assign herself. Either way, Vera calls up this claim and, after examining the claim, enters a decision as to whether Paul has fulfilled the conditions of the offer. Thus, the inspector process includes the following elements and steps:

1. SPQ authenticates an inspector.

2. SPQ enables the inspector to call up the claim record, which includes:

The offer sheet data, or a link to this data,

The prospect ID data, or a link to this data,

The acceptance data, or a link to this data,

The receipt data, or a link to this data.

(These data elements have been defined in Section 1.3)

3. SPQ enables the inspector to get an inspection report form which includes fields for the following information:

a) The name of the inspector

This field is for registering which inspector is handling the claim. SPQ can automatically fill in this field or enable the inspector to fill it in.

b) The claim locator number

This field is for identifying the claim. SPQ can automatically fill in this field or enable the inspector to fill it in.

c) The decision

This field is for stating whether the claim is approved or rejected.

d) The explanation

If the claim is rejected, the inspector will need to explain why. Thus the inspection report form will include a field for supplying a text explanation of why the claim was rejected. The explanation can be a “form letter” explanation that can be selected by the inspector.

4. When the inspector enters a decision, SPQ stores and timestamps the inspection report and links the report to the rest of the offer data and acceptance data for the prospect.

5. If the claim is rejected, SPQ executes the following steps

Sends an alert to the prospect telling him of the rejection and, in the alert, includes the explanation stored in the explanation field of the inspection form.

If the claim is approved, SPQ can execute the steps spelled out in Section 1.5. At minimum SPQ:

Registers that the prospect is owed the payoff amount stated in the offer,

Sends notification of the amount owed the prospect to a process (inside SPQ or outside SPQ) for paying the prospect,

Sends an alert to the prospect telling him he has won.

Aside on Automating the Inspector Process Further

The inspection process can be automated in certain cases, but that does not concern us. We will assume that a human inspector is necessary.

### 10.5 REGISTERING SELLER PAYMENTS

In Section 1.4, we said that when the inspector approves a claim, SPQ registers that the prospect is owed the payoff amount stated in the relevant offer. However, we did not describe steps for actually paying the prospect and for getting payment from the seller.

SPQ is a system in which realbuyers are paid through EVPM bets, meaning that the amounts actually paid are payoff amounts that may be quite large. How SPQ enables payoff payments to be transacted from sellers to realbuyers depends on whether the seller assumes the payoff risk in the EVPM bets or whether SPQ assumes the risk. We discuss these possibilities below.

Note: In all cases below, if SPQ collects payment from sellers, SPQ will include well-known debit and/or credit account processes. Further, SPQ will include well-known mechanisms for accepting payment and for alerting a seller when her account has a low balance or an overdue balance. Further, SPQ will include well-known mechanisms for suspending a seller's offer when her payment account has fallen under a threshold.

1. Seller Assumes the Risk in the EVPM Bets

If Sela assumes the payoff risk, SPQ does not necessarily have to collect payment from her. In this case, SPQ is an accounting machine in the sense that it registers payment obligations but does not transfer actual payment. In this case, SPQ includes steps for alerting sellers of their payment obligation and for alerting winning realbuyers that they are owed the relevant payoff amount from a given seller.

For example, assume that IBM is paying prospects to view a commercial, and assume that Paul wins $10,000 in an EVPM bet based on this offer and, assume that Paul turns out to be a realbuyer. Then, SPQ may simply alert Paul that IBM owes him $10,000 and will alert IBM that it owes Paul $10,000. Alternatively, SPQ can include means for transferring payment from sellers to winning realbuyers. These means include steps for:

Establishing a debit (or credit) account for a seller,

For receiving funds into in this account,

For transferring payment from a seller account to a realbuyer.

2. SPQ Assumes the Risk in the EVPM Bets

If SPQ assumes the payoff risk, the situation is a little more complicated. The problem is that Sela is offering EV payments only to realbuyers, but prospects who accept her offer will include realbuyers and non-buyers.

Assume that Sela offers realbuyers $1 to call her flower shop. Now, assume that 2000 prospects accept her offer and one of them wins the EVPM bet for $1,000 and is a realbuyer as well. So, this prospect is paid $1,000 by SPQ.

But how much does Sela owe SPQ? If she pays $1 per acceptance of her offer, that is not fair because she is only supposed to pay for realbuyers. She does not know, and SPQ does not know, what percentage of acceptors were realbuyers. The only way to get an accurate estimate is if Sela has very large numbers of acceptors. In this case she might as well assume the payoff risk herself.

But, if she does not have a large volume of acceptors, then SPQ must apply a discount rate to the EV amount that Sela offers to realbuyers. This discount factor is applied to each valid acceptance. Thus, each time a prospect accepts her offer, Sela would not owe SPQ the full amount of the EV payment stated in the offer, but a discounted rate.

For example, if the EV amount offered to realbuyers is $1 and the discount factor is 10%, then Sela would owe SPQ 10 cents per acceptance. SPQ would register those 10 cents per unique acceptance.

The goal in a discount factor is to represent the percentage of acceptors who are realbuyers. To arrive at a fair discount factor, the general idea is to get good statistics on what percentage of acceptors are realbuyers. This percentage will vary depending on the product/service involved.

SPQ may include one or more formulas to determine the discount factor for a given seller and the seller's product or service. The formulas will use data on how many acceptors converted into winning realbuyers. SPQ can feed this data into the discount formula(s). Other methods, such as survey methods can be used as well to yield discount factor data to be fed into discount formulas as well.

The main point here is that if SPQ assumes the payoff risk it will include:

a discount formula (or formulas) for arriving at a discount factor,

a discount factor to be applied to the EV amount that is offered.

Further, when a prospect accepts an offer, SPQ will:

apply the appropriate discount factor to the EV payment,

deduct the resulting amount from the seller's debit account,

transfer the amount to an SPQ account that is used to pay winning realbuyers.

3. SPQ Enables the Seller to Choose to Take the Risk in EVPM Bets

SPQ can enable Sela to choose whether or not to assume the payoff risk. The system would simply include both kinds of payment processes discussed above. In this case, SPQ could enable Sela to check a box in the process of establishing her account in which she signifies that she will take the payoff risk in all payment offers to prospects. Alternatively, the SPQ offer sheet can include a check box where Sela signifies that she will take the payoff risk for the particular offer.

### 10.6 PRODUCING SELLER REPORTS

A process for producing reports for sellers is not strictly necessary for the minimal operation of SPQ. Yet, it is so useful that we note, here in Chapter 10, that SPQ will include steps for enabling Sela to view:

a) how many unique prospects accepted her offer,

b) possibly, the identities of those prospects,

c) how many of those prospects won the EVPM bets,

d) how many of the winners turned out to be realbuyers,

e) how much she has spent on RB offers (we have discussed this data in section 1.5).

There are many more useful report statistics that can be generated for sellers. We give a more detailed discussion in Part 3 of this specification.

### CHAPTER 20

### ADDING STANDARD CONDITIONS to an RB OFFER

### 20.0 INTRODUCTION TO CHAPTER 20

Problem to Be Solved

How to attract desired realbuyers and increase the profitability of RB offers?

Vague Solution: Add Standard Conditions to the RB Offer

An RB offer is a fundamental kind of offer that a seller can make to attract high probability prospects. It is a payment offer, and so the general goal is to make that payment profitable, on average. But, in its minimal form, an RB offer suffers from a variety of weaknesses because it is too general. It does not, for example, discriminate between a prospect who buys something for $10 and a prospect who buys something for $1000. Clearly, it can be very useful for Sela to add conditions to an RB offer that discriminate between realbuyers according to their projected profitability.

A minimal RB offer has a variety of specific shortcomings that can be addressed through specific conditions. In this chapter we will describe a variety of such conditions that Sela can add to tailor an RB offer to achieve particular goals, especially to attract realbuyers according to their probability of buying. These conditions are levers, “tuners”, that determine who an RB offer will attract and how profitable the RB offer will be.

SPQ can include the following means for enabling Sela to add such conditions to her RB offer and make these conditions clear to prospects:

SPQ's offer form can include fields for specifying these conditions.

SPQ can show prospects these conditions when it presents her offer.

SPQ's search functionality can include these conditions as screens. (This screening capability is highly useful, in particular, if SPQ is a directory of offers entered by multiple sellers.)

In certain cases, SPQ can enforce a condition.

Below we list a number of important conditions that SPQ can enable Sela to add to an RB offer. After explaining a condition and its importance we will describe how SPQ handles the offer in the seller process, the prospect process and the inspector process (in the inspector process, no important steps are added usually; an extra condition is simply verified by an inspector, just as the other terms in the offer are verified.)

### 20.1 PURCHASE AMOUNT CONDITION

It should be possible for Sela to vary the amount of an RB payment based upon how much Paul spends. For example, Sela should be able to offer more to a realbuyer who buys a set of golf clubs than she pays to one who buys a set of golf balls. Indeed, varying the payment amount based on how much the realbuyer spends is a fundamental way to discriminate between realbuyers. Therefore, an important feature SPQ can include is one that enables Sela to make the payment amount to Paul contingent how much he spends. In other words, SPQ can enable her to set a purchase amount condition.

SPQ can enable her to vary the amount through a formula that specifies a percentage of the purchase amount. For example, if the percentage is 1% then Paul gets paid 1% of the amount he spends. (James Stein suggested this method.)

Although this method is easy to use, Sela may not want to vary her payment offer based upon a formula. For example, she may want to offer $15 to realbuyers who spend between $1000-$2000 and pay $1 to realbuyers who spend between $100-$200. The amount she is willing to pay will usually be determined by the rate other sellers are paying for a given purchase level for the same products. Competitive offers cannot be predicted by a simple formula, unless competitors are also using a percentage approach.

Still a formula can be very useful, especially at lower spending levels so that Sela does not have to go to the trouble of entering small offers for low purchase amounts, i.e., she does not have to enter an amount for each $10 increment in the purchase amount.

Hence, SPQ can give Sela the option of setting her payment according to a formula and/or setting it by the purchase amount intervals. Further, SPQ can enable her to set a percentage figure for various spending levels, e.g., 1% for purchase amounts between $1,000 and $2,000. That way the payment offers will vary smoothly for an interval.

Elements and/or Steps in the Seller Process

In the seller process, SPQ can enable Sela to vary her payment offer according to purchase amount by providing, in the offer form, fields in which she can set a purchase amount interval and a corresponding payment amount, e.g.:

| Purchase Amount | Payment Amount |
|---|---|
| <$50 | $0 |
| >$50 and <$100 | $1 |

Alternatively, the form can enable her to set apurchase amount percentage, per interval, such that the payment amount is the purchase amount multiplied by the percentage. For example, if she might fill into a table:

| Purchase Amount | Payment Percentage |
|---|---|
| <$50 | 1% |

Elements and/or Steps in the Prospect Process

In the prospect process, as part of its offer request form, SPQ can include fields for specifying how much Paul intends to spend.

Then, when he submits the request form, SPQ outputs the payment amounts that match that spending level (and that match the other criteria he enters). SPQ can also enable Paul to see all the spending levels and corresponding payment offers that Sela has made.

If Paul accepts the offer, SPQ stores the payment amount in the acceptance record.

Then, when SPQ determines whether Paul is a winner, it does so by choosing the random number range according to the payment amount stored in the acceptance record.

Elements and/or Steps in the Inspector Process

In the inspector process, a purchase amount condition does not involve any significant additions. Vera simply verifies the amount Paul has spent.

### 20.2 PURCHASE PERIOD CONDITION

As discussed, in the core seller process, SPQ enables Sela to set the time period within which Paul has to buy the product she is advertising. It is also possible for SPQ to enable Sela to vary the amount she will pay based upon the time period that Paul buys.

Elements and/or Steps in the Seller Process

Thus, SPQ's offer form can include fields for enabling Sela to enter time periods and corresponding payment amounts, e.g.,

| Purchase Period | Payment Offered |
|---|---|
| 0-10 days | $.50 |
| 11-20 days | $.25 |
| 21-30 days | $.10 |

Elements and/or Steps in the Prospect Process

In the prospect process, SPQ can, in the offer request form, provide a field in which Paul can specify when he intends to buy. SPQ can then find the payment offers that match this time period (and the other search criteria Paul enters). When SPQ finds Sela's offer, it can also show all the payments Sela is offering and their purchase period requirements.

### 20.3 LOCATION OF THE PROSPECT CONDITION

When Sela sells predominantly to a local market, it usually makes no sense for her to make an RB offer to anyone except prospects in her local market. Of course, there are exceptions, but the point is that a powerful targeting condition on a RB offer is a location condition, in which Sela specifies that the offer is only open to prospects who are located (live or work in) a given area.

Thus, in its offer form, SPQ can provide a field in which Sela can specify the location of realbuyers. Depending on the implementation, she can do this by using any geographical unit the system allows her to designate.

In the prospect process, SPQ can provide a field in the offer request form in which Paul states his location, for example, his zip code. Then SPQ finds those offers that match his search parameters and the zip code.

In this way, Sela's offer is only exposed to prospects who match the location that she has specified. Sela is protected from realbuyers who have little probability of buying from her, and Paul is able to find a seller in his locale.

In the inspector process, Vera simply verifies that Paul lives or works where he says he does. She can do this by having Paul submit some form of ID. Thus, the claim form that Paul uses may include not only receipt data but also personal ID data. Alternatively, Vera may request Paul's ID data after she has verified the receipt.

### 20.4 PAYMENT VEHICLE CONDITION

A general weakness of RB offers is that Sela is vulnerable to cheaters. Here is not the time to discuss the possible cheats; suffice to say that one kind of cheat revolves around the type of payment vehicle that is used. The more traceable the vehicle, such as a credit card, the less easy it is to cheat (for example, by backdating receipts).

Hence SPQ can enable Sela to set payment amounts according to the type of payment vehicle Paul uses. A credit card or other EFT means might have the highest payment amount while cash might have the lowest. As with other conditions we have discussed, a pricing mechanism is used to discriminate between realbuyers. Those who are more likely to cheat, as indicated by the payment vehicle, receive a lower payment offer.

Thus, SPQ can include a field in its offer form for enabling Sela to vary her payment offers according to the payment vehicle. SPQ can enable her to use a formula such that the amount offered for one vehicle is proportional one of the others. Or SPQ can enable Sela to fill in the amounts manually. Filling them in manually may be chore, given that there are several kinds of payment vehicles available, such as credit card, check, purchase orders, a variety of EFT methods, and cash. Given that she may also be stratifying offers according to purchase amount (discussed above), a formula method may be best.

### 20.5 PLACE OF PURCHASE CONDITION

As noted, a general weakness with RB offers is that Sela is vulnerable to cheating. One basic cheat, when SPQ is an online directory, is that Paul can buy from offline sellers that he already knows rather than new sellers he finds through the directory. Another cheat is collusion with an offline seller, which is usually easier with online sellers, in general.

A simple remedy is to enable Sela to offer different payments to Paul depending on whether he buys through an offline or online seller. Thus, a pricing mechanism can be used to discriminate between offline realbuyers and online realbuyers.

To enable this condition to be added to her offer, SPQ can provide a field, in the offer form, for stating a payment amount for offline RB's and for online RB's. In the prospect process, SPQ can enable Paul to search according to whether he intends to buy offline or online. SPQ can then output both amounts, since Paul may be unsure where he will buy.

Just as SPQ can enable Sela to discriminate between online and offline buyers, SPQ can also enable her to set a payment amount for a realbuyer who buys from a seller found in the SPQ directory. The seller does not have to be Sela, but could be a competitor of hers. The importance of this condition is that realbuyers who buy from the SPQ directory are, in general, more likely to buy from Sela, who herself is in the directory. Thus, it can be worthwhile to offer such realbuyers more than realbuyers who buy from anyone.

By the same principle, SPQ can also enable Sela to use pricing mechanisms to discriminate based upon the country where the purchase is made.

### 20.6 WHO THE REALBUYER BUYS FROM CONDITION

For Sela it is quite important that Paul be genuinely interested in buying from her. The biggest threat to her is that Paul is cheating, that he is collecting a payment from her simply because he knows he is going to buy the product she sells from another seller.

This threat is especially damaging when she is offering large payments and the incentive to cheat is large. One novel way that she can increase the odds that Paul is interested in buying from her is to restrict her offer such that Paul can only get paid if he buys from her or one of a set of sellers that she names, the sellers she feels that she is competing against. She can name them specifically, e.g., MCI, UUNET, or describe them in some fairly clear way, e.g., sellers in Los Angeles.

Indeed, for large payments, especially those to business buyers who are making large purchases, this condition can be critical because it assures Sela as to who her competition is. For example, if she is selling business class Internet service that sells for $2,000 per month, she may want to pay Paul only if he is considering buying from a small set of Internet Service Providers that she thinks she is comparable to.

The problem with this kind of condition is that it may unduly restrict Paul. Nevertheless, it is so powerful a targeting device that we can expect to see it in practice. For example, Sela might advertise in a print publication, We'll pay you $100 to call us if you are going to buy high speed Internet Access within the next 3 months and you plan to buy from an ISP with revenues greater than $200 million dollars, that operates in Los Angeles.

Thus, SPQ's offer form in the seller process can include a field for stating that her offer is contingent upon Paul buying from a set of sellers that Seal designates in the form.

In the prospect process, SPQ can enable Paul to enter a seller that he is considering buying from, and if Sela has named that competitor say, MCI, in her condition then SPQ can find the offer for Paul. More likely, SPQ will simply present the condition to Paul when it outputs Sela's offer. (Paul may already know the condition because he may have read it in an ad somewhere and uses SPQ in order to accept the offer.)

(A variation on the condition above is one in which Sela requires that Paul buy from a seller he has never bought from before. This condition is hard to verify, though, even with high payoffs, and probably will not be practical in the market. We mention it because it potentially is a powerful targeting condition.)

### 20.7 REBATE CONDITION

There is a condition that SPQ can enable Sela add to an RB offer that enables sellers to pay for the attention of realbuyers into a machine that enables sellers to offer rebates—discounts, that is—to realbuyers.

The way it works is quite simple. Sela simply adds to her offer the condition that Paul buys her product from her. Now, instead of a payment for attention, Paul is being offered an EV rebate, which he is eligible to collect on if he indeed buys from Sela. For example, if Sela sells flowers, she can offer Paul an EV rebate if he buys those flowers from her.

Thus, SPQ's offer form can included a condition that Paul gets paid only if he buys from the seller. In the prospect process, SPQ can show Paul this condition, and can allow him to search for rebate offers. In general, a rebate offer will allow larger payments to be made because Sela is only obligated if Paul buys from her.

The EV rebate can be a static number such as $2 or it can be a percentage of the purchase price. If it is a percentage, then, a payoff multiple would be used to determine whether Paul has won because the exact EV will not be known until Paul reports the purchase amount. He has no reason to report the amount until he finds out he has won. Hence a purchase multiple method where there is one winning number and it is an integer is selected from 1-multiple.

It is also possible to do two-stage selections where the first selection determines whether Paul has the right to enter a second selection. If he wins the first selection, SPQ can inform him that he has won the first selection and ask him to report whether he has purchased or not. If he has purchased, he can supply the purchase amount, then the second selection can be made using a payoff multiple, or a standard payoff amount.

The rest of the process, including inspection is all the same, except that inspection is probably easier and more amenable to automation, in general.

A rebate condition can be used by a manufacturer to offer a rebate to Paul if he buys the manufacturer's product from any seller. For example, Duracell can offer a 50 EV cent rebate on it's AAA 4-pack of batteries to Paul regardless of where he buys them.

The rebate amounts are not restricted to small amounts; they can be arbitrarily large, depending on the efficiency of the application.

By enabling sellers and manufacturers to make an RB offer with a rebate condition, SPQ becomes not only a pay-for-attention system, but also a general-purpose machine for transacting rebates. To make these purposes distinct, SPQ can enable users to choose a rebate offer or an RB offer. In fact, SPQ could be split into two machines, one for transacting RB offers and one for transacting rebates.

### 20.8 DECISIONMAKER CONDITION

Another important condition that Sela can add is one that requires Paul to be the decisionmaker at his organization if he is to claim an EV payment when his organization buys from Sela. This condition, though, may be implicit—that is, if Paul claims and EV payment based on a purchase by the organization he works for, then he must prove that he is a key decisionmaker. It is possible for SPQ to include a standard field for a decisionmaker condition, but it is more likely that the definition of decisionmaker is taken to be understood as part of the meta-rules of the system, or that the definition will be determined on a custom basis by each seller.

### CHAPTER 30

### EMBODIMENTS

### 30.0 INTRODUCTION TO CHAPTER 30

### Problem to Be Solved

How to implement SPQ to suit different kinds of attention, different kinds of advertising?

### Solution

The SPQ core processes disclosed in Chapter 10 can be adapted to sellers to pay for different kinds of attention from prospects, corresponding to different kinds of media. Advertising messages are not restricted to webpages. In this chapter we will describe various embodiments that have the features needed to adapt the core process to apply to specific kinds of attention, to specific media for communicating sales messages, that is.

### Organization of this Section

We will divide advertising (the communication of a sale message) into five media types: (a) webpage, (b) video, (c) phone call, (d) email and, (e) person-to-person meeting.

For each of these types, multiple embodiments can be constructed. We cannot be exhaustive, of course, in describing these embodiments and will focus on a small number of specific embodiments, explaining the key features for each embodiment. The key differences within these embodiments do not have to do with the seller process or the inspector process; those remain mostly (although not entirely) the same for each media type. The main differences are in the prospect process and they revolve around three sub-processes:

1) registering the prospect's identity,

2) exposing the prospect to the sales message, which may or may not involve SPQ,

3) enforcing the prospect's attention, which may or may not involve SPQ.

One point from the Preface bears repeating. SQP can be a single, integrated system or it can be made up of linked computers that perform different tasks and communicate with each other. This fact is evident as we describe specific embodiments. For example, the identification of the prospect—and the rest of the prospect interface—may be handled by a computer that communicates with a linked computer that holds the SPQ database. As noted, the distribution of functions does not change the essential nature of the invention.

The Assumption Is that SPQ Is a Service Bureau

In this chapter we will assume that SPQ acts as a service bureau that is used by multiple sellers to post RB offers.

We can further assume that prospects identify an offer by entering a code into the SPQ interface. SPQ uses the code to find the corresponding offer. For example, IBM may state in a print ad, Call 1-800-r-e-a-l-b-u-y and enter “I-B-M” at the appropriate prompt in order to get paid $2 to talk to one of our representatives. In this case, the code I-B-M would correspond to an offer that IBM has entered into SPQ in the seller process.

Or, we can further assume that the interface itself communicates the code to SPQ, which would be the case if the interface enables Paul to find an offer simply by pressing a button. In this case, the pressing of the button would correspond to a certain code that would then be communicated to the SPQ database to identify a specific offer.

The general idea is that the central database can serve a variety of front-ends that are used to interface with prospects. We will give illustrations as we describe embodiments.

(We note that if SPQ enables different kinds of RB offers that correspond to different media, that in the seller process, SPQ's offer form would include a standard field for designating the type of attention that the seller was paying for. In the prospect process, the SPQ would show this designation to the prospect, if necessary, to distinguish between different RB offers that the seller was making.)

When we describe embodiments, we will strive to not repeat the description of Chapter 10. We will often recap what was said in Chapter 10, for the sake of clarity, but will try to only add matter where necessary. Where there is no need to add commentary we say, “remains the same”, which means that we have nothing to add to what was explained in Chapter 10.

Contents of this Chapter

Section 30.1 SPQ for webpage ads and video ads

Section 30.2 SPQ for phone calls

Section 30.3 SPQ for email ads

Section 30.4 SPQ for person-to-person sales meetings.

### 30.1 SPQ FOR WEBPAGE AND VIDEO ADS

Problems

How to pay a realbuyer for paying attention to a webpage ad? Similarly, how to pay a realbuyer for paying attention to a video ad?

Solutions

Embodiments of SPQ's core processes can enable sellers to pay realbuyers for paying attention to webpage and video ads. We describe embodiments for webpage ads and for video ads in the same section because the processes are basically the same.

We assume that SPQ is a directory in which sellers post RB offers. Prospects will find these offers by entering lookup codes. When an offer is presented to a prospect, a link is shown which the prospect can select. When the prospect selects the link, the ad, whether a webpage or a video, is served to the prospect. In this section we describe one basic embodiment and features that can be added to it, as follows:

30.11 SPQ for Viewable Ads

30.12 Service Bureau Features

30.13 Attention Enforcement Features

### 30.11 SPQ for VIEWABLE ADS

Scenario

In this sub-section, we describe how the core processes are implemented as a directory of RB offers that enables realbuyers to be paid for viewing ads. Using this directory, Paul finds an offer by entering a lookup code into the directory. When the offer is presented to him, a link is shown which he can select. When he selects the link, he accepts the corresponding RB offer and receives the corresponding ad. We will call this embodiment SPQ for Viewable Ads (SPQ-FVA). This name is somewhat of a misnomer since email ads are viewable but we choose it for brevity.

### 30.11a The Seller Process for SPQ-FVA

Sela enters her offer into SPQ-FVA through a website interface, using an offer form. Below, we describe the data she enters and how SPQ-FVA uses it to enable Paul to accept her offer. We list the fields of an offer sheet form, disclosed in Chapter 10, and add descriptive matter only as necessary. When we say, “remain(s) the same”, that means we have nothing to add to what was said in Chapter 10.

Field 1: Name Used by the Seller for the Offer Document

Remains the same.

Field 2: Data for Enabling Prospects to Find an

Offer

In the case of the SPQ-FVA, the data for finding Sela's offer is a lookup code specified by her. SPQ will check to insure that the code is unique to the system but it is up to Sela to decide what the code is. (The code can, of course, be a phrase.) Sela specifies the code because she can advertise it outside SPQ. For example, she might show the code in a print ad, e.g., If you are going to join a health club in the next 30 days, go to realbuyers.net and enter “Bally's Health Club” into the search engine.

(SPQ-FVA can also include search functions for enabling prospects to find lookup codes according to the name of the seller.)

Field 3: Data for Accessing the Advertising

In the case of an SPQ-FVA, the data for accessing the advertising is a URL or an equivalent address code. This address is presented as a link when Paul finds the offer. Paul can then select the link to receive the ad. We do not mean to limit the application to URL's and corresponding website. The address code enables an ad to be server to Paul from whatever ad server that the address corresponds to—e.g., an ad server for an interactive TV network.

Field 4: Amount of EV Payment

Remains the same.

Field 5: Realbuyer Conditions

Remain the same. We elaborate in sub-section 3.13.

Field 6: Controls

Remain the same.

Additional Descriptive Material

The offer form may include a field for enabling Sela to enter data describing herself and her offer. This descriptive data is then presented by SPQ to Paul when he finds her offer.

Steps for Enabling Payment by a Seller

Remain the same. 30.11b The Prospect Process for an SPQ-FVA

Here we recap the steps of the core prospect process, adding matter where necessary to describing how the process is implemented for an SPQ-FVA embodiment.

1. Register the Prospect's Identity.

If it is Paul's first time using SPQ-FVA, SPQ will present him with a form for creating an account. The form will include fields for entering a user ID and password and additional ID data specifying Paul's legal name and, possibly, additional ID data, such as a social security number. The goal is to have his log-on identity correspond to a single, legal identity so that he can be paid and so that he cannot use multiple identities. (SPQ will include functions for ensuring that his legal ID only corresponds to one log-on identity.)

After Paul has set up his account, SPQ stores the account data and associates his log-on ID with his legal ID for the purposes of paying him.

2. Find and Present the Offer.

Paul enters the lookup code for Sela's RB offer and SPQ-FVR finds the offer and presents it as a link to be selected.

We noted in the discussion of the offer form above that SPQ-FVA may enable Sela to enter a description of herself and her offer. If so, the link would be accompanied by text describing the offer and/or describing Sela.

3. Register Acceptance of the Offer

If Paul selects the link presented to him, he signifies acceptance of the offer. SPA registers the acceptance in an acceptance record.

Alternatively, it is possible that simply entering the lookup code will suffice as signifying acceptance of the offer. In this case, SPQ does not need to present a link to Paul.

4. Connect the Prospect to the Seller's Advertising.

If Paul selects the link presented to him, the corresponding ad is served to him. The ad may be a webpage or a video. The ad will be served by a machine controlled by Sela or another party, as specified by the ad address that Sela supplied in the seller process.

Alternatively, it is possible that simply entering the lookup code will suffice as a command by Paul to view the ad corresponding to the offer. In this case, SPQ does not need to present a link to Paul. SPQ will simply connect Paul to the ad, as specified by the ad address that Sela supplied in the seller process.

(We note that it is possible for SPQ to serve the ad. If SPQ serves the ad, it will also require means for enabling Sela to load the ad into an SPQ ad server. This functionality would be integrated into the prospect process.)

5. Verify that Attention is Paid.

Remains the same. We take up this functionality in sub-section 3.13.

6. Apply the Rule in Effect Regarding Multiple Acceptances.

Remains the same.

7. Select a Random Number From a Range Dictated by the EV Payment and the Payoff (or the Payoff Multiple).

Remains the same.

8. Record the Results of the Random Number Generation.

Remains the same.

9. When the Time Requirement Has Expired, Inform the Acceptor That He Has Won.

Remains the same.

10. Receive and Register Claim.

Remains the same.

11. Pass the Claim to the Inspector Process.

Remains the same.

Payment Steps in the Prospect Process

Remain the same, basically.

### 30.13c The Inspector Process for an SPQ-FVA

Remains the same.

### 30.13d Payment Processes for an SPQ-FVA

Remain the same.

### 30.12 SERVICE BUREAU FEATURES for an SPQ for VIEWABLE ADS

SPQ-FVA can also be a service bureau that enables any properly configured website to be a front-end that prospects interact with. This embodiment is useful for a seller who wants to enable prospects to see and accept her RB offer at her website.

SPQ can act as a service bureau for any number of sites. Sellers still enter their offers through a central SPQ website while the prospects interface with the distributed websites.

In this scenario, SPQ includes means for receiving data from the front-end sites. This data set was described in previous sections. Accordingly, the front-end site will:

register Paul's' ID,

present Paul with a RB offer (and possibly enable him to find an offer),

register acceptance of the offer,

send the data it registers to the central SPQ-FVA database.

The front-end site must be configured with a program for sending this data to the central SPQ-FVA database. (The data will be associated with the particular RB offer, of course). Correspondingly, the central database requires means for receiving this data from the front-end sites.

A front-end site can include database functionality such that it holds an ID record of Paul. Alternatively, the front-end site can send Paul to an SPQ webpage that enables Paul to enter his ID data. Likewise, rather than send a set of data to the SPQ database, the front-end site might just send Paul to a SPQ webpage that is identified with the particular RB offer that Sela wants Paul to accept. The SPQ webpage can then handle the necessary data registration. The point is that there are various well-known possibilities for implementing a front-end.

The key aspect, for our purposes, is that the essential processes of the SPQ-FVA database do not change. The database simply needs functionality for receiving data for a particular RB offer from distinct, distributed front-ends. The utility of the system can be greatly enhanced by this functionality because SPQ's front-end can be a set of widely distributed websites and not just a central directory site or guide.

### 30.13 ATTENTION ENFORCEMENT FEATURES

Where paying for attention is concerned, it is usually quite useful for Sela to be able to verify that Paul has actually viewed her ad. Where webpage and video ads are concerned, there are two basic attention verification methods:

(1) measuring the time that Paul has spent viewing the ad

(2) requiring that Paul interact with the ad.

There are a variety of well-known mechanisms for timing a viewer. Likewise, there are well-known mechanisms for enabling Paul to interact with an ad and registering that interaction. We do not delve into these mechanisms.

The point, for our discussion, is that SPQ-FVA can include means for receiving an attention verification signal from the server that is serving the ad to Paul. This signal will be keyed to the particular ad and corresponding RB offer. This signal will be sent based on Paul's interaction with the ad, or the time he has spent viewing the ad, depending on the verification method that is used.

If SPQ-FVA has the task of verifying attention then it will cancel Paul's acceptance of an RB offer if it does not receive this signal.

While we do not delve into particular methods for verifying Paul's interaction with an ad and how a corresponding verification signal can be sent to SPQ, we will briefly mention two general methods so that we can describe the mechanisms SPQ will include to enable Sela to use SPQ's attention verifying functionality.

One method applies where the ad server follows a custom SPQ protocol for sending verification data to SPQ. In this case, the offer form can include a field for enabling Sela to specify a standard attention condition, such as interacting with Sela's ad in a certain way. According to the protocol, the attention verification signal will indicate whether or not Paul has met this condition.

A second method is to enable Sela to enter a verification code into the offer form. In this method, we assume that when Paul views an ad, the ad gives him the opportunity to click on a link to indicate that he is viewing the ad. This link will cause the ad server to send a verification code to SPQ that is unique to the ad. Along with the code, the ad server can send the ad's address. Thus, when SPQ receives the code, it can check the offer data and match it with the ad's address and with the verification code. This data is not enough. In order for SPQ to verify that Paul has been viewing, SPQ must also receive Paul's ID back from the ad server. Therefore, we also assume that when SPQ enables Paul to be served the ad, it sends a code to the ad server to identify Paul. The ad server sends this ID back to SPQ along with the verification code and the ad address. With these data, SPQ can register that Paul has fulfilled the attention condition.

### 30.2 SPQ FOR PHONE CALLS

### 30.20 Introduction to Section 30.2

Problems to Be Solved

How to implement SPQ to pay a realbuyer for calling a seller? Similarly, how to pay a realbuyer for taking a call from a seller?

### Solutions

Different kinds of embodiments of SPQ can enable sellers to pay realbuyers for paying attention over the phone. In this section, we describe several embodiments and include a sub-section (3.38) on features that can be added to these embodiments:

3.21 Manual Data Capture at Call Destination

3.22 Interactive Voice Response Data Capture at Call Destination

3.23 Interactive Voice Response Phone Switch

3.24 Click-to-Call Website Directory

3.25 Automatic Phone Switch Phone-line circuitry

3.26 Promise-to-Call Verification System

3.27 Seller-Calls-Prospect Registration Systems

3.28 Additional Features for SPQ's for Phone Calls

### 30.23 USING AN INTERACTIVE VOICE RESPONSE PHONE SWITCH

Scenario

One way that SPQ can enable a seller to pay realbuyers for calling is to have prospects call an interactive voice response (IVR) system linked to a phone switch that registers the prospects and routes calls to the seller.

Under this scenario, Sela enters her offer at an SPQ website that is the front-end for entering offers. Paul accepts her offer using the front-end for prospects, which is an IVR system. For example, Sela could advertise her RB offer in a magazine ad that states, Are you are a realbuyer? We'll pay you $2 to call us. Call 1-800-Realbuy and enter code #202-333-7777. Under this scenario, SPQ's IVR front-end and phone switch register Paul's ID data, capture the code that he enters, and route the call to Sela's phone number, which she has entered as part of her offer.

In addition to completing the call, the phone switch registers the length of the call. Importantly, this data enables SPQ to enforce the attention condition that is implicit or explicit in Sela's offer—e.g., she might specify that Paul has to stay on the phone for 60 seconds or more in order to collect an EV payment.

The IVR front-end does not have to process the data it registers; it can simply send the data to the central SPQ database, which then executes the rest of the prospect process. In this sub-section, we will describe the steps that SPQ takes under this scenario.

We will call this embodiment SPQ Using an IVR Switch or the IVR switch.

### 30.23a The Seller Process in which SPQ Uses an IVR switch

In the IVR switch embodiment, Sela enters her offer into SPQ through a website interface, using an offer form. Below, we describe the data she enters and how SPQ uses it to enable Paul to accept her offer. We list the fields of an offer sheet form, disclosed in Chapter 10, and add descriptive matter only as necessary. When we say, remain(s) the same, that means we have nothing to add to what was said in Chapter 10.

Field 1: Name Used by the Seller for the Offer Document

Remains the same.

Field 2: Data for Enabling Prospects to Find an Offer

In the case of an IVR switch embodiment, the data for finding and accepting Sela's offer is a lookup code specified by Sela that corresponds uniquely to an offer or offers from her. We will assume, for simplicity and user-friendliness, that the code is the phone number that she wants Paul to call. In certain situations, Sela may have different RB offers that apply to the same phone number, and so, SPQ can enable her to distinguish between offers by adding an extra number to her phone number—e.g., 202-333-7777-1, 202-333-7777-2, and so on. (Sela's payment offer may vary depending on the amount that Paul spends. This kind of “multi-offer” does not affect the lookup code.)

Field 3: Data for Accessing the Advertising

In the case of an IVR switch, the data for accessing the advertising is the phone number that Sela wants Paul to call. (If the phone number does not also serve as the lookup code, then Sela must enter the phone number into a phone number field.)

Field 4: Amount of EV Payment

Remains the same.

Field 5: Realbuyer Conditions

The discussion of these conditions remains the same but let us elaborate. Where paying for a realbuyer to call, the key attention condition is time spent on the call. This time period may be standard or set by Sela. If Sela sets it, there will be a field for enabling her to do so. Another condition that is possible is a “time-of-day” condition, in which Sela specifies a certain time period for Paul to call. Like the “duration-of-the-call condition”, this condition can be verified in the prospect process.

Field 6: Controls

Remain the same.

Steps for Enabling Payment by a Seller

Remain the same.

### 30.23b The Prospect Process in which SPQ Uses an IVR Switch

Here we recap the steps of the core prospect process, adding matter where necessary to describing how the process is implemented for an IVR switch embodiment.

1. Register the Prospect's Identity.

The exact method for identifying Paul depends upon the implementation.

An IVR system can identify a prospect by a personal identification number (PIN). The goal for the operation of SPQ is to link a PIN with Paul's legal identity, so that he can be paid, and so that he cannot use multiple PIN's.

Therefore, SPQ can require that Paul pre-register his legal identity at an SPQ website that lets Paul choose a PIN that SPQ associates with his legal identity with the PIN.

An alternative is to enable Paul to register his legal ID through the IVR system, if it is his first time using SPQ. SPQ can let him choose a PIN as if he was using a website. The IVR system can enable him to enter his full name and address and unique identifying data. A minimal amount of data may be necessary. For example, the IVR interface may enable Paul to enter just his social security number. His PIN can then be associated with this data so that if he wins a payoff, his PIN can be associated with a unique, legal ID.

Of course, another alternative for assigning a PIN is to enable Paul to call a human operator who enters Paul's ID data into SPQ and assigns Paul his PIN.

Yet another alternative is to not associate a PIN with legal ID data, such as a social security number or a full name. It is possible to enable Paul to make up his own PIN and enter it via the IVR interface. The reason to use this method of identifying Paul is user-friendliness; Paul has to enter less data. This method is vulnerable to cheating in that Paul may register multiple identities. Still, it may be feasible to use such a method if SPQ includes other cheat detection processes, such as tests for detecting users who win an abnormal number of times. Therefore, just a PIN, determined by Paul, may suffice to identify Paul to the system.

2. Find the Offer.

Paul enters the lookup code for Sela's RB offer. We assume that the lookup code is Sela's phone number. The IVR interface registers the number and sends it to the switch.

3. Connect the Prospect to the Seller's Advertising.

The switch connects Paul with the Sela's number.

4. Register Duration of the Call.

The switch registers the time/date and duration of the call. This data enables the seller to be charged toll charges, if they apply, and enables SPQ to verify that Paul has paid enough attention to qualify for the EV payment Sela has offered.

5. Send Data SPQ Database

The IVR system and switch send the following data to the SPQ central database (where the rest of the prospect process is executed):

a. Paul's PIN,

b. the lookup code (which we assume is Sela's phone number)

c. the duration of his call,

d. the time/date of the call.

(Note: if the IVR is also used to enter Paul's legal identity and assign a PIN, then the IVR system would also send this data to the SPQ central database.)

6. Possibly, Register Toll Charges to the Seller.

If SPQ routes calls such that there is a toll charge, which will usually be the case, SPQ will also assess a charge to be paid (in most cases) by Sela based on the duration of the call. The charge is registered to Sela's account, which is identified by her phone number.

7. Verify Realbuyer Conditions, in Particular, that Attention is Paid.

We assume that Paul must spend a threshold amount of time on the call to Sela's number in order to collect his EV payment. Sela may set the threshold as part of the terms of her RB offer, or the threshold may be standard. Thus, SPQ checks if the duration of the call is greater than the threshold. If it is not, SPQ does not register an acceptance. If Sela sets the threshold then SPQ must identify the offer and compare the duration of Paul's call with her custom threshold. SPQ identifies her offer by the lookup code (by Sela's phone number).

Another realbuyer condition, discussed above, is that Paul must call during a certain period in the day, e.g., during business hours. Thus, if this condition applies SPQ can check whether Paul has met it as well. If he has not, SPQ does not register an acceptance.

8. If Enough Attention is Paid, Register an Acceptance.

If the duration of the call is greater than the threshold required, SPQ registers the acceptance of Sela's offer in an acceptance record. As noted, SPQ identifies the offer by the lookup code.

9. Apply the Rule in Effect Regarding Multiple Acceptances.

Remains the same.

10. Select a Random Number From a Range Dictated by the EV Payment and the Payoff (or the Payoff Multiple).

Remains the same.

11. Record the Results of the Random Number Generation.

Remains the same.

12. When the Time Requirement Has Expired, Inform the Acceptor That He Has Won.

Since Paul accesses SPQ via a voice interface, one way that SPQ can enable Paul to find out whether he has won the EVPM bet is to enable him to call the IVR interface, enter his PIN and, select a menu option for checking results. The IVR system can then connect with the SPQ central database and report to him if he has any “wins” for any RB offers he has accepted. Alternatively, SPQ can include a visual web interface that enables him to do the same thing—i.e., enter his PIN (user ID and password) and select a command for checking the results of his EVPM bets—of his acceptances of the RB offers, that is.

13. Receive and Register Claim.

Remains the same.

14. Pass the Claim to the Inspector Process.

Remains the same.

Payment Steps in the Prospect Process

Remain the same except for the addition, depending on the implementation, of assessing toll charges to sellers. Where Paul accesses Sela by phone through the SPQ switch, toll charges will usually apply. If so, these charges need to be paid by someone. There are various ways to assess these charges to users. One way is to assess the charge to Sela. If so, SPQ will need to assess the charge as part of the prospect process, as discussed above.

### 30.23c The Inspector Process in which SPQ Uses an IVR Switch

Remains the same.

### 30.23d Payment Processes in which SPQ Uses an IVR Switch

The possible processes for transacting EV payments remain the same. Steps that may be added involve registering toll call charges, as discussed in sub-section 3.23b above.

### 30.23e Producing Seller Reports

Remains the same.

### CHAPTER 40

### ADDITIONAL METHOD AND FEATURES

### 40.0 INTRODUCTION TO CHAPTER 40

In this chapter we elaborate on methods and features previously described. Further, we describe additional methods and features that can be incorporated into the larger methods and systems already described. Some of these features apply only to the realbuyer application; others apply broadly to the core method.

40.1 Handling Uncertain Purchase Amounts

We have already explained that a payoff can be a predetermined multiple of the EV payment. This approach is especially useful in many sales situations in which a realbuyer would be paid an EV payment that is a percentage of his purchase. For example, a seller could offer a realbuyer 1% of the realbuyer's purchase. But, until the realbuyer declares his purchase, the seller does not know how much 1% amounts to. Under the core method of the invention, the purchase amount is revealed when a realbuyer is selected as a provisional winner, so it is impractical to state in advance how much in EV dollars a seller will pay. However, it is practical to pay a multiple of a percentage of a sale. For instance, a seller could offer to pay an EV of 1%, where the payoff is set at 500 times the EV. Thus, the payoff is 500% of the purchase amount. What 500% amounts to could be determined if the realbuyer is a winner, and his purchase amount is revealed.

Another problem with determining a purchase amount involves cases where payments are made over time, as in a rental or credit agreement. In this case, the method could be adapted so that EV payment bets are made per period that money is owed by the realbuyer. Thus, each payment dues would be effectively treated as a separate purchase. This is one approach, although not the only one, that could be adopted.

40.2 Two-Stage Selection in Expected Value Payments

In many sales situations it is advantageous to make the EV payment a two-stage, random selection process in which a realbuyer must “win” both stages in order to collect a payoff. For example, a realbuyer might have a 1/1,000 chance of winning, in which the first stage would be 1/50 and the second stage would be 1/20.

Under this method, if the realbuyer won the first stage the realbuyer would be asked whether he made a purchase or not. His answer would be recorded, and he would only be eligible for the second stage if he won the first.

Two-stage selection has a few advantages. It enables system statistics to be collected about purchasing frequency, without basing those statistics purely on people who collect payoffs. It can help prevent cheating because it enables system operators to spot people who win first-stages too frequently. Further, it can provide an appealing way to advertise the payment method itself because many first-stage winners will be attracted to the method and will tell friends about how they almost won a payoff.

40.3 Inspecting a Fraction of the Claims

We expect that in most implementations of the core method, a claimant would have to put up a deposit, to ensure that his claim was valid. The deposit would be forfeit in the claim were invalid. A twist on this idea, to increase the efficiency of inspection, it is to ask claimants to put up a large deposit, and only inspect a fraction of the claims. The rest of the claims would be assumed valid, where the claimants put up the large deposit, that is.

I claim:

1. A method for paying a group of recipients for their attention to a message, comprising:
(a) identifying an advertiser and an associated payment offer having at least one condition;
(b) associating an expected value (EV) payment, and a corresponding payoff, with the recipients,
(c) determining acceptance of the offer by recipients;
(d) selecting at least one of the recipients at random with a probability being set at EV/Payoff;
(e) determining whether the selected at least one recipient satisfies the at least one condition; and
(f) based on a positive determination, providing the payoff to the selected one of the recipients.
